(19) United States
(12) Patent Application Publication
(10) Pub. No.: US 2019/0149552 A1
(43) Pub. Date: May 16, 2019

(54) Systems and Methods for Dynamic Authentication and Communication Protection Using an Ephemeral Shared Data Set

(71) Applicant: InfoSci, LLC, Haymarket, VA (US)

(72) Inventor: John ELLINGSON, Haymarket, VA (US)

(21) Appl. No.: 16/230,644

(22) Filed: Dec. 21, 2018

Related U.S. Application Data
(63) Continuation-in-part of application No. 16/038,908, filed on Jul. 18, 2018.
Application No. 16/038,908 is a continuation of application No. 15/493,572, filed on Apr. 21, 2017, now Pat. No. 10,057,269.
Application No. 15/493,572 is a continuation-in-part of application No. 16/148,651, filed on Oct. 1, 2018.
Application No. 16/148,651 is a continuation of application No. 15/788,981, filed on Oct. 20, 2017, now Pat. No. 10,122,699.
(60) Provisional application No. 62/610,209, filed on Dec. 24, 2017.
(60) Provisional application No. 62/513,047, filed on May 31, 2017.

(51) Int. Cl. H04L 29/06; G06F 16/951; G06F 21/62

(52) U.S. Cl. CPC H04L 63/101; G06F 16/951; H04L 63/0428; G06F 21/62; H04L 63/08

(57) ABSTRACT

Various embodiments provide methods and computing devices configured to implement the methods for protecting device communication. Various embodiments may include selecting elements from an ephemeral shared data set stored in the computing device and in an access point, generating a rule set indicating the selected elements, generating a first dynamic session key based on the selected elements, sending the generated rule set to the access point, receiving a second dynamic session key from the access point, determining whether the first dynamic session key matches the second dynamic session key, and determining that the access point is authenticated in response to determining that the first dynamic session key matches the second dynamic session key.

### RELATED APPLICATIONS

This continuation-in-part application claims the benefit of priority to U.S. Provisional Patent Application No. 62/610,209 filed Dec. 24, 2017, U.S. Non-Provisional application Ser. No. 16/038,908 entitled “Systems and Methods for Device Verification and Authentication” filed Jul. 18, 2018, which claims priority to U.S. Non-Provisional application Ser. No. 15/493,572 entitled “Systems and Methods for Device Verification and Authentication” filed Apr. 21, 2017, and U.S. Non-Provisional application Ser. No. 16/148,651 entitled “Systems and Methods for Ephemeral Shared Data Set Management and Communication Protection” filed Oct. 1, 2018, which claims priority to U.S. Provisional Application No. 62/513,047 entitled “Systems and Methods for Dynamic Shared Data Set Management and Communication Protection” filed on May 31, 2017 and U.S. Non-Provisional application Ser. No. 15/788,981 entitled “Systems and Methods for Ephemeral Shared Data Set Management and Communication Protection” filed Oct. 20, 2017, the entire contents of all of which are hereby incorporated by reference.

### BACKGROUND

The development of the digital environment has enabled a vast expansion in rapid communication and information transactions, among other things. However, the security paradigm from the past used in this new environment has inherent vulnerabilities: the concept of shared secrets and the concomitant trust. The paradigm of the shared secret has been incorporated into the digital environment in numerous ways—from usernames and passwords, to secure communications between users and systems. For example, this concept is foundational to the Secure Socket Layer, Certificate Authority, Public Key Information security infrastructure.

However, the digital environment is one in which secrets are difficult to keep for more than a short period of time, and once secrecy is lost the formerly secret information may be proliferated rapidly and with complete fidelity. The digital environment is also one in which shared secrets and credentials have become a primary target of “hacking” that has transformed many “secrets” (e.g., passwords, digital certificates, private information and other types of authentication data) into a commodity freely traded on the gray and black markets, destroying the benefit of such secrets for securing digital exchanges. Yet, the underlying security mechanism of the digital environment remains dependent upon the safe operation of this false assumption that the secret is still secret.

Verification of the presented identity and authentication of a computing device is a critical aspect of numerous electronic communications. However, the vulnerability of shared secrets, as well as the vulnerability of communications in transmission, dramatically undermines the reliability and security of digital certificates or other similar information for trusted device identity verification.

### SUMMARY

Various embodiments provide methods and computing devices configured to implement the methods for securing communications between two computing devices on a WiFi communication network by continuous refreshing and changing of a shared data set used to secure the communications. Various embodiments provide methods and computing devices configured to implement the methods for securing communications between a computing device and a WiFi access point. Various embodiments provide methods and computing devices configured to implement the methods for the dynamic generation of a value that may be used to protect a communication based on the dynamically changed (e.g., ephemeral) shared data set. Various embodiments incorporate the assumption that trusted systems ultimately are demonstrably insecure, because such systems are penetrable and vulnerable. Various embodiments provide a digital communication system that assumes no trust among various network elements, for at least the reason that the digital environment is inherently untrustworthy.

Various embodiments may include selecting elements from an ephemeral shared data set stored in a computing device and in an access point, generating a rule set indicating the selected elements, generating a first dynamic session key based on the selected elements, sending the generated rule set to the access point, receiving a second dynamic session key from the access point, determining whether the first dynamic session key matches the second dynamic session key, and determining that the access point is authenticated in response to determining that the first dynamic session key matches the second dynamic session key.

In some embodiments, selecting elements from an ephemeral shared data set stored in the computing device and in the access point is performed in response to one of sending by the computing device a handshake request to the access point and receiving by the computing device a handshake request from the access point.

Some embodiments may further include enabling communication with the access point in response to determining that the access point is authenticated. Some embodiments may further include determining that the access point is not authenticated in response to determining that the first dynamic session key does not match the second dynamic session key. Some embodiments may further include preventing communication with the access point in response to determining that the access point is not authenticated.

Some embodiments may further include selecting second elements from a second ephemeral shared data set stored in the computing device and a second computing device, generating a second rule set indicating the selected second elements, generating a first result the selected second elements, sending the second rule set to the second computing device via the access point, receiving an encrypted message from the second computing device via the access point, attempting to decrypt the encrypted message using the first result, and determining whether the attempted decryption was successful.

Some embodiments may further include determining that the second computing device is authenticated in response to determining that the attempted decryption was successful. Some embodiments may further include encrypting a communication using the first result in response to determining that the attempted decryption was successful, and sending the encrypted communication to the second computing device via the access point.

Further embodiments may include computing devices configured with processor-executable instructions to perform operations of the methods summarized above. Further embodiments may include processor-readable storage media on which are stored processor-executable instructions configured to cause a processor of a computing device to perform operations of the methods described above. Further embodiments may include computing devices including means for performing functions of the methods described above.

### BRIEF DESCRIPTION OF THE DRAWINGS

The accompanying drawings, which are incorporated herein and constitute part of this specification, illustrate example embodiments of the invention, and together with the general description given above and the detailed description given below, serve to explain the features of the invention.

FIGS. 1A and 1B are component block diagrams of communication systems suitable for use with various embodiments.

FIG. 2 is a component block diagram of a communication device suitable for use with various embodiments.

FIG. 3 is a process flow diagram illustrating a method 300 of managing an ephemeral shared data set according to various embodiments.

FIG. 4 illustrates relationships among elements of portions of a data set 500 according to various embodiments.

FIGS. 5A-5D illustrate relationships among elements of portions of ephemeral shared data sets 500a-500d according to various embodiments.

FIGS. 6A-6C illustrate representations of methods of managing an ephemeral shared data set according to various embodiments.

FIG. 6D illustrates a transformation of a first data format or type to a second data format or type.

FIG. 7 illustrates a method 700 of managing synchronization of an ephemeral shared data set according to various embodiments.

FIG. 8 illustrates a method 800 of dynamically altering an ephemeral shared data set according to various embodiments.

FIG. 9 illustrates a method 900 of performing a dynamic session handshake utilizing an ephemeral shared data set according to various embodiments

FIG. 10 illustrates a method 1000 for protecting a communication according to various embodiments.

FIG. 11 illustrates a method 1100 of managing synchronization of an ephemeral shared data set of computing devices according to various embodiments

FIG. 12 illustrates a method 1200 for protecting a communication between computing devices according to various embodiments.

FIG. 13 is a component block diagram of a mobile wireless computing device suitable for implementing various embodiments.

FIG. 14 is a component block diagram of a portable wireless communication device suitable for implementing various embodiments.

FIG. 15 is a component block diagram of a server device suitable for implementing various embodiments.

FIG. 16 is a component block diagram of an access point device suitable for implementing various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

Various embodiments provide methods, and computing devices (or other digital or programmable devices) configured to implement the methods, that enable the management of a shared data set. In various embodiments, the shared data set may be stored at two or more computing devices. In some embodiments, the shared data set may be dynamic, and may be altered from time to time. In various embodiments, the shared data set may be ephemeral, and may be altered after a relatively short period of time. In some embodiments, the dynamically-altered shared data set may provide a vast amount of complex random data using a relatively small starting data set. In various embodiments, the ephemeral shared data set may be used by two or more computing devices to generate a dynamic value. In some embodiments, the dynamically-generated value may be used to protect a communication between the two or more computing devices.

In various embodiments, the communication system may employ the dynamically-changing shared data and the dynamically generated value to protect the communication in a manner that does not rely on the paradigm of shared secrets and static information.

Because the ephemeral shared data set may be changed dynamically from time to time (e.g., upon the occurrence of a trigger event, periodically, aperiodically, etc.), and the dynamically generated value may be based on the dynamically changing ephemeral shared data set, various embodiments improve the security function of any communication network or any electronic communication system by improving the security of communications. Various embodiments also improve the security function of any communication network or system by using an ephemeral (dynamically changing) shared data set and a dynamically generated value. Thus, various embodiments do not rely on easily compromised static identification information such as a shared secret (e.g., a shared certificate for a shared key, such as may be used in the public key infrastructure (PM)) that may be vulnerable to attack by access and/or copying. Various embodiments also improve the security function of any communication network or system because the dynamic shared data set is not transmitted from one computing device to another. Various embodiments also improve the security function of any communication network or system because the dynamically generated value is not transmitted from one computing device to another.

The term “computing device” refers to any programmable computer or processor that can be configured with programmable instructions to perform various embodiment methods. A computing device may include one or all of personal computers, laptop computers, tablet computers, cellular telephones, smartphones, Internet enabled cellular telephones, Wi-Fi enabled electronic devices, personal data assistants (PDAs), wearable computing devices (including smart watches, necklaces, medallions, and any computing device configured to be worn, attached to a wearable item, or embedded in a wearable item), wireless accessory devices, memory sticks, dongles, wireless peripheral devices, Internet of Things (IoT) devices, systems and devices that function as part of a Supervisory Control and Data Acquisition (SCADA) system, autonomous vehicles, semiautonomous vehicles, and remotely directed vehicles, smart firearms, network elements such as servers, routers, gateways, and the like (including so-called “cloud” computing devices), and similar electronic devices equipped with a short-range radio (e.g., a Bluetooth, Peanut, ZigBee, and/or Wi-Fi radio, etc.) and/or a wide area network connection (e.g., using one or more cellular radio access technologies to communicate using a wireless wide area network transceiver, or a wired connection to a communication network). A computing device may also include a microcontroller device such as an Arduino board, Amtel chip, and the like, which may process instructions with or without an operating system.

The terms “component,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, an object, an executable, a thread of execution, a program, and/or a computer. By way of illustration, both an application running on a wireless device and the wireless device itself may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

Among other things, the digital environment enables rapid communication and information transactions on up to a global scale. However, the current digital environment rests on a shaky security foundation: the old paradigm of the static shared secret. There are numerous fundamental differences between the purely human environment we operated in for thousands of years until the late 20th century and the digital environment we operate in today.

Further, the digital environment is one in which secrets are difficult to keep over time. Once secrecy is lost the formerly secret information may be proliferated rapidly and with complete fidelity and used by attackers. Breakdowns in digital system security, resulting in massive data breaches, have become nearly commonplace and the frequency of their occurrence has accelerated.

Indeed, the emergence of the rapidly expanding, multibillion dollar cybersecurity industry is indicative of the endemic failure of security in general throughout the digital environment. As but one example, cybercrimes such as identity fraud are among the fastest growing crimes, with threats continuing to accelerate in capability and scale. The proliferation of network-connected devices, including smart phones, wearable computers, gaming systems, Internet of Things devices, and the like is exacerbating the scale and extent of digital security risks. For example, many of these devices are either themselves untrustworthy or are interacting with untrustworthy mobile networks, and few such devices have the computing power to perform traditional security functions of familiar desktops and laptops.

In the majority of the breach incidents, a violation of trust or the misuse of a shared secret (e.g., a credential) is at the root of the failure. While in certain cases a particular security failure may be due to a lack of strength in the technology employed to provide the trust and security, in general security failures in the digital environment have occurred in a wide variety of industries using a variety of technology deployments. Security failures occur across the board and are attributable not only to any particular deployed technology, but also to the practices and procedures inherent to its application and use. Thus, security failures in the digital environment are due to something more fundamental and endemic in the root strategy of the trust paradigm of the shared secret that has failed.

The current obsolete paradigm of digital security fails for at least three fundamental reasons: (1) the current paradigm is based on trust, and trust is frequently violated or misplaced; (2) the current paradigm is based on maintaining stable or static shared secrets, but the secrets do not remain secret, and are as useful to an attacker as to an authorized user; and (3) the vast majority of information transactions are between anonymous parties (strangers). Thus, “trusted systems” ultimately do not work because they are penetrable and vulnerable. Moreover, current “trusted systems” are vulnerable to penetration and exploitation in large part due to the use of static or durable information that does not vary with time (or duration); and failures of policy and human factors (e.g., social engineering, negligence, etc.). The vulnerability of shared secrets dramatically undermines the reliability of digital certificates or other similar information to protect communications.

Various embodiments disclosed in this application address the security vulnerability of digital systems and improve electronic security for device-to-device communication. Various embodiments provide computer-implemented methods to provide for continuous refreshing and changing of an ephemeral shared data set. Various embodiments provide computer-implemented methods to provide for the dynamic generation of a value that may be used to protect a communication based on the dynamically changed ephemeral shared data set. Various embodiments incorporate the assumption that trusted systems ultimately are demonstrably insecure, because such systems are penetrable and vulnerable. Various embodiments provide a digital communication system that assumes no trust among various network elements, for at least the reason that the digital environment is inherently untrustworthy.

Various embodiments enable the generation of a vast amount of random data from a relatively small initial information set. Various embodiments enable the dynamic alteration of the data set such that the data set is altered unpredictably. In some embodiments, the dynamically altered data set, or a subset thereof, may be provided to or obtained by two or more computing devices, such that the two or more computing devices each store an ephemeral shared data set. In some embodiments, the ephemeral shared data set of the two or more computing devices may be dynamically altered. In some embodiments, alterations of the ephemeral shared data set may be synchronized such that the altered data set remained shared by the two or more computing devices.

Various embodiments enable the generation of a dynamic value by the two or more computing devices. In some embodiments, the dynamic value is generated based on the ephemeral shared data set. In some embodiments, the dynamic value may be used to encrypt a communication transmitted between the two or more computing devices.

Various embodiments also improve the security function of any communication network or system because the dynamic shared data set is not transmitted from one computing device to another. Various embodiments also improve the security function of any communication network or system because the dynamically generated value is not transmitted from one computing device to another.

Since a common threat vector is typically theft of credentials such as certificates and key information, rather than use of computing power to decrypt encoded authenticating information, various embodiments improve the security of communications in a communication network by dispensing with fixed credentials. In some embodiments, the dynamic shared data set may exist in one state for a relatively short period of time, which may be minutes, or even seconds. In some embodiments, the dynamic value may be usable to encrypt and decrypt only one communication. This contrasts with the effective duration of certificates from a conventional certifying authority (CA), which may have a duration of up to decades in some cases. The relatively short useful duration and the inherent complexity of the ephemeral shared data set and the dynamic value reduces by orders of magnitude the possibility of such information being guessed, accessed, or “hacked” and then used as a means of attacking the system.

Further details relevant to various embodiments are disclosed in U.S. patent application Ser. No. 15/493,572 entitled “Systems and Methods for Device Verification and Authentication” filed Apr. 21, 2017 and U.S. patent application Ser. No. 15/788,981 entitled “Systems and Methods for Ephemeral Shared Data Set Management and Communication Protection” filed Oct. 20, 2017, the entirety of both of which are incorporated by reference into this application.

Various embodiments include systems and methods for managing an ephemeral shared data set stored by two or more computing devices. In various embodiments, the two or more computing devices may include any two endpoint devices in a computing network, such as a user device, a network server, an authentication server, or another computing device. In various embodiments, the two or more computing devices may include endpoint devices in a computing network and an access point, such as a router, a Wi-Fi access point, or another similar device. The ephemeral shared data set may be compiled over time, and may be changed by a computing device occasionally, periodically, and/or upon the occurrence of a triggering event. Changing or altering the ephemeral shared data set may include reordering one or more portions of the data set, adding information to the data set, subtracting information from the data set, and/or transforming one or more portions of the ephemeral shared data set. The ephemeral shared data set may include two or more portions. Each portion of the data set may include two or more elements. In some embodiments, a computing device may determine a relationship between two or more elements of an ephemeral shared data set. The relationship between the two or more elements may include a comparative difference between the two or more elements, such as a time difference, a location difference, a positional difference, a color difference, a pitch difference, a frequency difference, or another difference. The relationship between the two or more elements may also include a comparative difference between each of the two or more elements and a third element, such as a relative time, location, position, color, pitch, frequency, or another difference.

In some embodiments, the plurality of files may include a plurality of image files. In various embodiments, the computing devices may use an agreed upon method for altering the ephemeral shared data set that enables both computing devices to alter the ephemeral shared data set while maintaining an identical ephemeral shared data set. In some embodiments, instructions for altering the ephemeral shared data set may be provided to the computing devices by a network element, such as a data set manager (e.g., a data set management device). In some embodiments, the alterations of the ephemeral shared data set may be determined dynamically by the data set manager and/or the computing devices (e.g., “on the fly”).

In some embodiments, the data set manager may dynamically generate one or more instructions to alter the ephemeral shared data set. In some embodiments, the instructions may include an instruction to replace the ephemeral shared data set. In some embodiments, the instruction may include an instruction to add a new data set portion. In some embodiments, the instruction may include an instruction to subtract a portion of the ephemeral shared data set. In some embodiments, the instruction may include an instruction to reorder the ephemeral shared data set. In some embodiments, the instruction may include an instruction to transform the ephemeral shared data set.

In various embodiments, performing one or more transformations to the ephemeral shared data set enables the generation of a very large number of unpredictable element values and relationships among data elements from a relatively small number of portions. In various embodiments, simple computations, or computations that are not processor intensive, may generate vast complexity from a relatively small and/or simple starting data set. In contrast to conventional secret information (such as a PM certificate, which is representative of one-dimensional, linear computations), the dynamic data set may be multidimensional (n-dimensional), and may provide vastly greater complexity and conventional secret information by several orders of magnitude. Further, various embodiments may determine relationships between and among elements of the ephemeral shared data set. Performing a transformation on the data set may change the various relationships between and among the data elements. As but one example, an image file may include a number of pixels, and each pixel may be associated with a number of different values, such as location information within the image file, color, hue, saturation, black and white value, and other such pixel information. Even without transformation, the image file may contain a unique set of information. A processor may perform the transform on one or more image files, thereby changing not only the values of the various pixels in the transformed image files, but also numerous relationships among the data elements of the transformed image files and other portions of the data set.

In some embodiments, one of the computing devices (a first computing device) may send an indication to the data set manager that the computing device has a communication to send to a second computing device. In response to the indication from the first computing device, the data set manager may generate instructions to extract one or more elements from the ephemeral shared data set, and may send the extraction instructions to the first and second computing devices. According to the instructions, the first and second computing devices may extract the elements from the ephemeral shared data set. In some embodiments, the extraction instructions may include an indication of the element(s) to be extracted. In some embodiments, the extraction instructions may include a rule set that enables each of the first and second computing devices to identify the element(s) of the ephemeral shared data set to be extracted. In some embodiments, the extraction instructions may include an instruction to perform a transformation operation on one or more of the extracted elements. In various embodiments, the extraction instructions may enable the first computing device and the second computing device to dynamically generate a unique set of elements that are shared by the first computing device and the second computing device (i.e., the extracted elements are stored at each of the first computing device and the second computing device), based on elements in the ephemeral shared data set.

In some embodiments, the first computing device may select elements from among the extracted elements. In some embodiments, the first computing device may generate a rule set indicating the selected elements. The rule set may identify the selected elements from among the extracted data elements of the ephemeral shared data set. In some embodiments, the computing device may generate the rule set based on one or more relationships between or among the selected data elements. In some embodiments, the rule set may identify a first element and one or more relationships among the first element and other data elements that enable a computing device to select the elements from the extracted elements based on the identity of the first element and the one or more relationships to the other data elements. The first computing device may send the generated rule set to the second computing device.

As one example, an ephemeral shared data set may include two or more image files, and each image file may include numerous pixels (picture elements). Each image file may be associated with additional data, such as a time stamp or other time information, location information and/or geolocation information where the image was obtained, weather information, and the like. Each pixel may be associated with a large number of information elements, such as a coordinate location in an image, color, intensity, luminosity, and the like. Each pixel may also be associated with the information of its respective image file. Thus, each pixel may be associated with a large number of information elements, which may be considered variables. In some embodiments, the rule set may include information identifying one or more pixels of the ephemeral shared data set. In some embodiments, the rule set may include information identifying one pixel of the ephemeral shared data set, and relationship information that enables the identification of one or more other pixels using the identified first pixel and the relationship information.

The ephemeral shared data set is not limited to image files, and a shared data set may be generated or compiled using data that may include identifiable data elements, and/or in which relationships between or among two or more data elements may be determined. Examples of such data include video files, audio files, biometric samples, location data (e.g., Global Positioning Satellite system data), and the like. Further, a rule set may include information identifying one or more data elements of a component of the ephemeral shared data set. In some embodiments, the rule set may include information identifying one data element and relationship information that enables the identification of one or more other data elements in a data set (e.g., elements selected from the extracted data elements).

In some embodiments, the first computing device may generate a first result based on the selected elements. In some embodiments, the generated result may include a string of data. In some embodiments, the generated result may include a value based on information in the elements selected from the extracted elements of the ephemeral shared data set. In some embodiments, the first computing device may perform a transform of the information of the selected elements, such as generating a hash of values of the information. In some embodiments, the first computing device may generate a data string based on the information of the selected elements and may perform a transform (e.g., generate a hash) of the information of the selected elements to generate the first result.

In various embodiments, a second computing device having the elements extracted from the ephemeral shared data set may receive the rule set from the first computing device, and may use the rule set and the extracted elements of the ephemeral shared data set to select the elements from the extracted elements. For example, the second computing device may apply the rule set to its stored extracted data elements to identify, e.g., pixels and their associated location, order in the data set, numerical values for color, density, etc. In some embodiments, the second computing device may create a data string from the application of the rule set.

In some embodiments, the second computing device may generate a second result based on the selected elements. In some embodiments, the generated result may include a string of data. In some embodiments, the generated result may include a value based on the information in the selected elements of the ephemeral shared data set. In some embodiments, the second computing device may perform a transform of the information of the selected elements, such as generating a hash of values of the information. In some embodiments, the second computing device may generate a data string based on the information of or within the selected elements and may perform a transform (e.g., generate a hash) of the data string to generate the second result.

In some embodiments, the second computing device may encrypt a message using the second result, and the second computing device may send the encrypted message to the first computing device. In some embodiments, the message may include a very small amount of data. In some embodiments, the encrypted message may function as a test message for sending to the first communication device to enable the first communication device to determine whether the second result generated by the second communication device matches the first result generated by the first communication device.

In some embodiments, the first communication device may receive the encrypted message from the second device, and may attempt to decrypt the message using the first result. For example, the first communication device may initiate a decryption process of the message. The first communication device may determine whether the decryption was successful. In some embodiments, in response to determining that the decryption was not successful, the first communication device may determine that the second computing device is not authenticated. In some embodiments, in response to determining that the decryption was not successful, the first communication device may send a synchronization query to the data set manager. In some embodiments, in response to the synchronization query, the data set manager may then generate new extraction instructions and send the new extraction instructions to the first and second communication devices. In some embodiments, in response to synchronization query, the data set manager, as well as the first and second communication devices, may perform synchronization operations to synchronize the ephemeral shared data set.

In various embodiments, each of the first computing device and the second computing device may select elements from among the extracted elements, and each of the first computing device and the second computing device may generate a rule set. In some embodiments, the elements selected by the first computing device may be different than the elements selected by the second computing device. For example, in some embodiments, the first computing device may generate a first rule set indicating the elements selected by the first computing device. In some embodiments, the second computing device may generate a second rule set indicating the elements selected by the second computing device. In some embodiments, the first computing device may send the first rule set to the second computing device, and the second computing device may send the second rule set to the first computing device.

In some embodiments, the first and/or second rule sets may include instructions/rules for how to combine the selected elements (i.e., elements selected by each device and the elements selected using the rule set from the other computing device) to generate a combined set of selected elements.

In some embodiments, the first computing device may generate a first result based on the elements selected by the first computing device. In some embodiments, the first computing device may select elements from among the extracted elements using the second rule set (from the second computing device). The first computing device may generate a second result from the elements selected using the second rule set. In some embodiments, the first computing device may combine the first result and the second result to generate a combined result.

In some embodiments, the second computing device may generate a third result based on the elements selected by the second computing device. In some embodiments, the first computing device may select elements from among the extracted elements using the first rule set (from the first computing device). The second computing device may generate a fourth result from the elements selected using the first rule set. In some embodiments, the second computing device may combine the third result and the fourth result to generate a combined result. In various embodiments, the combined results generated by each of the first computing device and the second computing device are the same.

In some embodiments, the first and/or second rule sets may include instructions/rules for combining the first and second rule sets to generate a combined rule set. Each computing device may then use the combined rule set to select the elements from among the extracted elements, and may use the selected elements to generate the combined result.

In some embodiments, the second computing device may encrypt a message using the combined result generated by the second computing device, and the second computing device may send the encrypted message to the first computing device. In some embodiments, the first communication device may receive the encrypted message from the second device, and may attempt to decrypt the message using the combined result generated by the first computing device. In response to determining that the decryption was successful, the first computing device may encrypt a communication using the combined result, and may send the encrypted communication to the second computing device. The second computing device may decrypt the communication using the combined result.

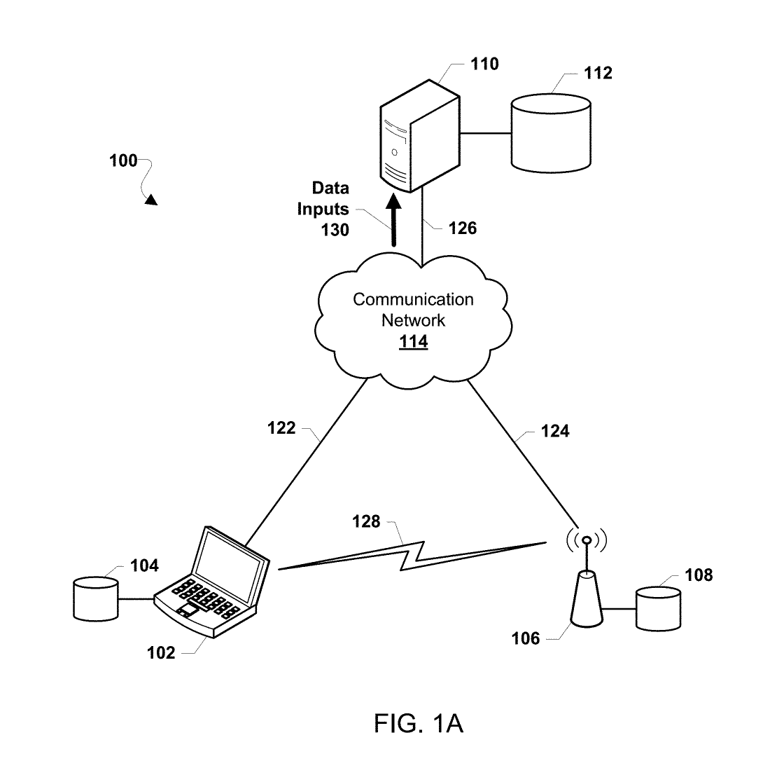

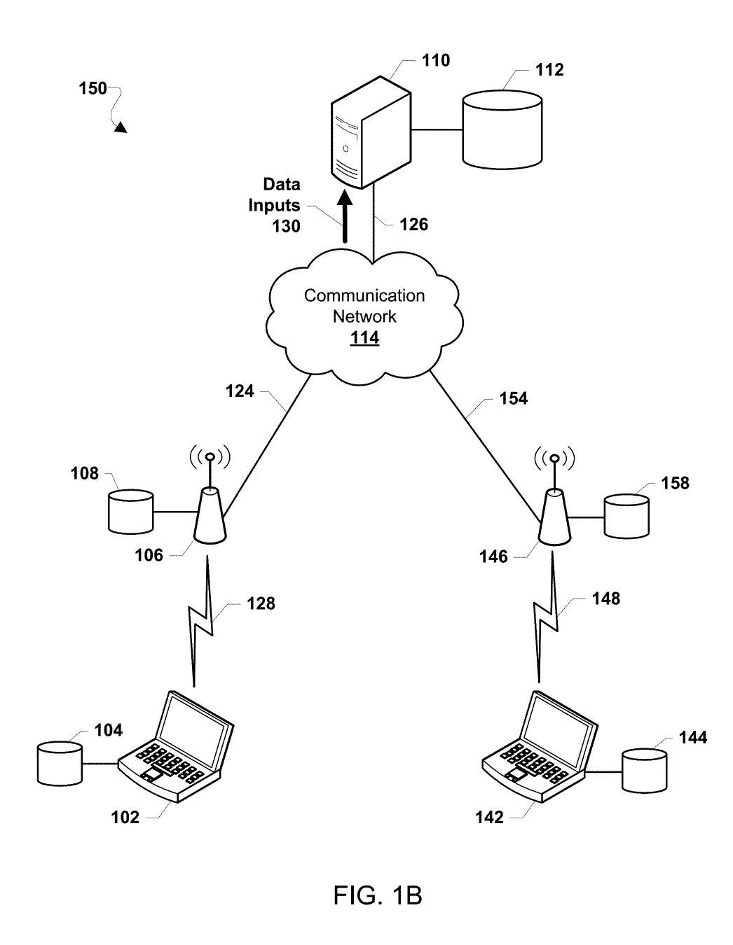

Various embodiments may be implemented within a variety of communication systems 100, an example of which is illustrated in FIG. 1A. The communication system 100 may include a computing device 102, an access point 106, and a network element 110. In some embodiments, the computing device 102 may include a computing device used directly by a user, such as a smart phone, a laptop computer, a desktop computer, and the like. In some embodiments, the access point 106 may include a network device, such as a wireless local area network (LAN) access point (e.g., a Wi-Fi access point), a router, a smart switch, an IoT router or hub, or another similar device.

The computing device 102 may include or be configured to communicate with a data storage 104, and the access point 106 may include or be configured to communicate with a data storage 108. It will be understood that a user may operate more than one such computing device similar to the computing device 102. In some embodiments, the computing device 102 may include an element in a SCADA system.

In some embodiments, the computing device 102 may include one or more IoT devices. Non-limiting examples of IoT devices include personal or mobile multi-media players, gaming systems and controllers, smart televisions, set top boxes, smart kitchen appliances, smart lights and lighting systems, smart electricity meters, smart heating, ventilation, and air conditioning (HVAC) systems, smart thermostats, building security systems including door and window locks, vehicular entertainment systems, vehicular diagnostic and monitoring systems, machine-to-machine devices, and similar devices that include a programmable processor and memory and circuitry for establishing wireless communication pathways and transmitting/receiving data via wireless communication pathways.

The computing device 102 may also include an unmanned, autonomous, semi-autonomous, or robotic vehicle capable of travel of travel on land, sea, air, or in space. The computing device 102 may further include a smart firearm or another processor-equipped weapon or weapon system.

In some embodiments, the network element 110 may include a back-end computing device such as a server. The network element 110 may include or be configured to communicate with a data storage 112.

Each of the computing device 102, the access point 106, and the network element 110 may communicate with a communication network 114 over a respective communication link 122, 124, and 126. The computing device 102 and the access point 106 may communicate over a communication link 128. In some embodiments, the communication network 114 may include two or more communication networks. The communication network 114 may include a variety of communication networks, including communication networks within an entity or enterprise, and external communication networks, publicly available communication networks, and combinations of networks as well as internetworks, including the internet. The communication network 112 may support communications using one or more wired and/or wireless communication protocols.

The communication links 122, 124, and 126 may include wired or wireless communication links, and may further include additional devices to facilitate communication between the computing device 102, the access point 106, the network element 110, and the communication network 114. Examples of such additional devices may include access points, base stations, routers, gateways, wired and/or wireless communication devices, as well as backhaul communication links that may include fiber optic backhaul links, microwave backhaul links, and other suitable communication links.

Each of the communication links 122, 124, 126, and 128 may be two-way wired or wireless communication links. Wireless communication protocols may include one or more radio access technologies (RATs). Examples of wireless RATs include 3GPP Long Term Evolution (LTE), Worldwide Interoperability for Microwave Access (WiMAX), Code Division Multiple Access (CDMA), Time Division Multiple Access (TDMA), Wideband CDMA (WCDMA), Global System for Mobility (GSM), and other RATs. Examples of RATs may also include Wi-Fi, Bluetooth, Zigbee, LTE in Unlicensed spectrum (LTE-U), License Assisted Access (LAA), and MuLTEfire (a system that uses LTE on an unlicensed carrier band). Wired communication protocols may use a variety of wired networks (e.g., Ethernet, TV cable, telephony, fiber optic and other forms of physical network connections) that may use one or more wired communication protocols, such as Ethernet, Point-To-Point protocol, High-Level Data Link Control (HDLC), Advanced Data Communication Control Protocol (ADCCP), and Transmission Control Protocol/Internet Protocol (TCP/IP).

In some embodiments, the computing device 102, the access point 106, and the network element 110 may be part of a secure network, such as an internal enterprise network, a government agency secure network, a virtual private network (VPN), or another similar network environment. In such a secure network, the communication links 122, 124, 126, and 128 may include additional security, such as encryption at one or more layers (i.e., Open Systems Interconnection (OSI) layers), and other implementations to secure communications along the communication links 122, 124, 126, and 128.

While the communication links 122, 124, 126, and 128 are illustrated as single links, each of the communication links may include a plurality of wired or wireless links, such as plurality of frequencies or frequency bands, each of which may include a plurality of logical channels. Additionally, each of the various communication links 122, 124, 126, and 128 may utilize more than one communication protocol.

In some embodiments, the network element 110 may be configured to manage a data set that may be stored in the data storage 112. In some embodiments, network element 110 may be configured to manage an ephemeral shared data set that may be stored in the data storage 104 of the computing device 102, and the data storage 108 of the computing device 106, as further described below.

In various embodiments, network element 110 may receive data inputs 130 over time. The data inputs 130 may include information that the computing device 130 may use to generate, alter, and/or manage a data set that may be shared with another computing device (e.g., the computing device 102 and the access point 106). The data inputs 130 may include, for example, images, photographs, video, sound recordings (e.g., music, ambient sound recordings, or another such recording), biometric information inputs (e.g., facial recognition scans, iris scans, DNA samples, voiceprint recordings, fingerprints, and the like), or any other such data input.

Various embodiments may be implemented within a variety of communication systems 150, an example of which is illustrated in FIG. 1A. The communication system 100 may include computing devices 102 and 142, access points 106 and 146, and the network element 110. In some embodiments, the computing device 142 may be similar to the computing device 102, and the access point 146 may be similar to the access point 106, as described. The computing device 142 may include or be configured to communicate with a data storage 144, which may be similar to the data storage 104. The access point 146 may include or be configured to communicate with a data storage 158, which may be similar to the data storage 108. The computing device 142 may communicate with the access point 146 over a communication link 148, which may be similar to the communication link 128. The access point 146 may communicate with the communication network 114 over a communication link 154, which communication link 154 may be similar to the communication link 124.

In various embodiments, the computing devices 102 and 142 may communicate with each other via their respective access points 106, 146 and the communication network 114.

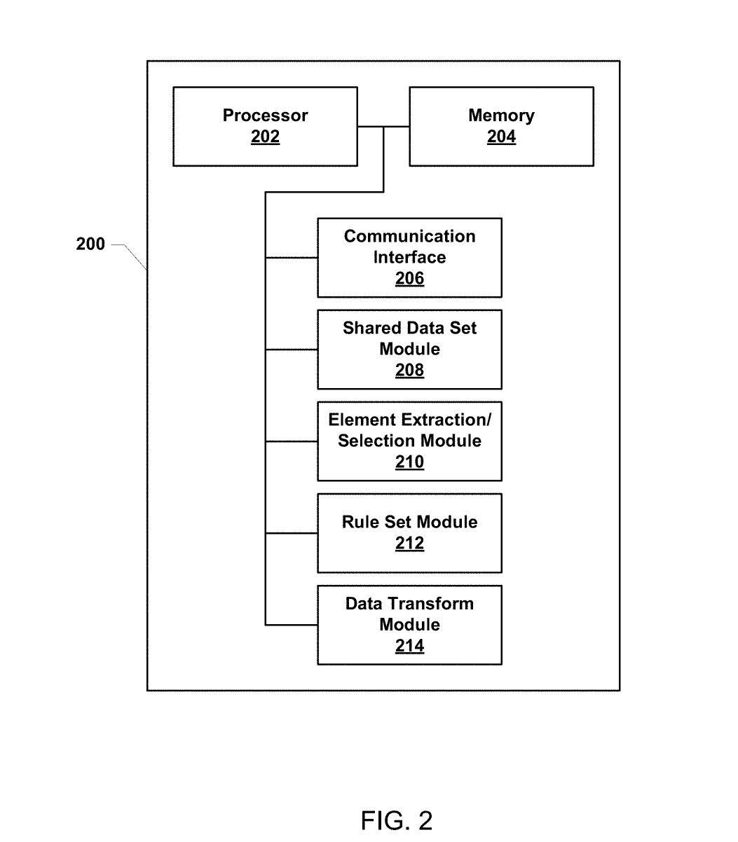

FIG. 2 is a component block diagram of a computing device 200 suitable for implementing various embodiments. With reference to FIGS. 1A-2, in various embodiments, the computing device 200 may be similar to the computing devices 102 and 142, and the access points 106 and 146. The computing device 200 may include a processor 202. The processor 202 may be configurable with processor-executable instructions to execute operations of the various embodiments, a specialized processor, such as a modem processor, configurable with processor-executable instructions to execute operations of the various embodiments in addition to a primary function, a dedicated hardware (i.e., “firmware”) circuit configured to perform operations of the various embodiments, or a combination of dedicated hardware/firmware and a programmable processor.

The processor 202 may be coupled to memory 204, which may be a non-transitory computer-readable storage medium that stores processor-executable instructions. The memory 204 may store an operating system, as well as user application software and executable instructions. The memory 204 may also store application data, such as an array data structure. The memory 204 may include one or more caches, read only memory (ROM), random access memory (RAM), electrically erasable programmable ROM (EEPROM), static RAM (SRAM), dynamic RAM (DRAM), or other types of memory. The processor 202 may read and write information to and from the memory 204. The memory 204 may also store instructions associated with one or more protocol stacks. A protocol stack generally includes computer executable instructions to enable communication using a radio access protocol or communication protocol.

The processor 202 may also communicate with a variety of modules for units configured to perform a variety of operations, as further described below. For example, the processor 202 may communicate with a communication interface 206, a shared data set module 208, and element extraction/selection module 210, a rule set module 212, and a data transform module 214. The modules/units 206-214 may be implemented on the computing device 200 in software, in hardware, or in a combination of hardware and software, including a firmware chip, system-on-a-chip (SOC), dedicated hardware (i.e., firmware) circuit configured to perform operations of the various embodiments, or a combination of dedicated hardware/firmware and a programmable processor. The processor 202, the memory 204, and the various modules/units 206-214 may communicate over a communication bus or any other communication circuitry or interface.

The communication interface 206 may include a network interface that may enable communications with a communication network (e.g., the communication network 114). The communication interface 206 may include one or more input/output (I/O) ports through which a connection, such an Ethernet connection, a fiber optic connection, a broadband cable connection, a telephone line connection, or other types of wired communication connection may be provided. The communication interface 206 may also include a radio unit that may enable radio frequency communication.

The shared data set module 208 may receive from the communication interface 206 information for use as a shared data set (e.g., from the network element 110). The shared data set module 208 may be configured to alter the shared data set according to instructions from the processor 202.

The element extraction/selection module 210 may be configured to extract and/or select one or more data elements from the shared data set.

The rule set module 212 may be configured to generate a rule set identifying the one or more data elements. The rule set module 212 may also be configured to parse or analyze a rule set received from another computing device so that the element extraction/selection module may use the received rule set to extract and/or select one or more data elements from the shared data set.

The data transform module 214 may be configured to perform one or more data transformations on one or more elements of the shared data set, one or more extracted elements, and/or one or more selected elements. The data transform module 214 may also be configured to perform operations to alter the shared data set.

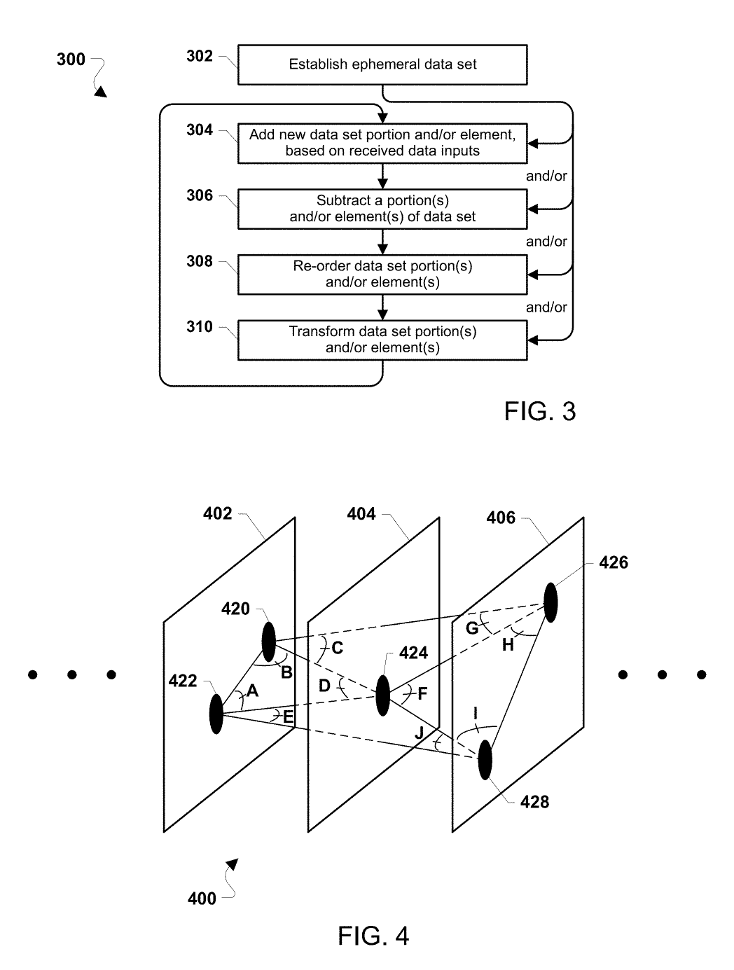

FIG. 3 illustrates a method 300 of managing an ephemeral shared data set according to various embodiments. With reference to FIGS. 1A-3, the method 300 may be implemented by a processor (e.g., the processor 202 and/or the like) of a computing device (e.g., the computing devices 102 and 142, the access points 106 and 146, and the network element 110).

In block 302, the processor may establish a data set. For example, the processor may receive data inputs (e.g., the data inputs 130) and may establish the data set based on one or more of the data inputs. The data inputs and the data set are further described below.

After the data set is established, the processor may perform one or more operations to alter the data set.

In block 304, the processor may to add a new data set portion and/or a new data element based on the received data inputs.

Additionally or alternatively, the processor may subtract one or more portions and/or one or more elements of the data set in block 306.

Additionally or alternatively, the processor may re-order one or more portions and/or one or more elements of the data set in block 308.

Additionally or alternatively, the processor may perform a transform of one or more portions and/or one or more elements of the data set in block 310.

Transforming an element and/or a portion may include performing one or more operations to alter one or more values of the element and/or portion. For example, transforming an element and/or a portion of an image or a video file may include rotating, flipping, inverting, shifting a position, shifting a color, applying a filter or preset transformation (e.g., as may be available in a photo or video editing software program), or another similar operation. As another example, transforming an element and/or a portion of a music or audio file may include raising or lowering pitches, reversing the content of the file, inverting the content of the audio file (i.e., transforming the content along a selected axis), adding an audio effect such as reverb, distortion, flanging, and the like, or another similar operation. As another example, transforming an element and/or a portion of the ephemeral shared data set may include transcoding data elements (e.g., transforming audio data into visual data or text). As another example, transforming an element and/or a portion of the ephemeral shared data set may include performing one or more mathematical functions to transform the element and/or portion.

FIG. 4 illustrates one example of an ephemeral data set 400 according to some embodiments. With reference to FIGS. 1A-4, in some embodiments, the ephemeral data set may include two or more portions. Each portion of the ephemeral data set may include one or more elements. In some embodiments, the portions of the ephemeral data set may include a discrete constituent, such as an image, a photograph, video, sound recording, a biometric input, or another such discrete constituent. In various embodiments, the ephemeral data set, or one or more portions and/or elements of the data set, may be used to generate an ephemeral shared data set that may be stored at two or more computing devices (e.g., the computing devices 102 and 142, and the access points 106 and 146)

The ephemeral data set 400 may include one or more portions, such as portions 402, 404, and 406. Each of the portions 402, 404, and 406 may include one or more elements. For example, portion 402 may include elements 420 and 422, portion 404 may include element 424, and portion 406 may include elements 426 and 428. In some embodiments, the portions 402, 404, and 406 may include discrete constituents, such as photographs, sound recordings, fingerprints, biometric data, or other discrete portions.

In some embodiments, the ephemeral data set 400 may be built up over time. For example, a computing device (e.g., the network element 110) may receive data inputs (e.g., the data inputs 130) and may build up an ephemeral data set 400 over time using the received data inputs. In some embodiments, the processor may provide some or all of the ephemeral data set 400 to two or more computing devices for use as an ephemeral shared data set.

In various embodiments, the elements 420-428 may include information that enables the identification or indexing of each element within a portion. For example, an element may include information identifying a location, position, and/or time of the element within its portion, or any other information that allows the indexing or identification of each selected element.

In various embodiments, the portions 402-406 and/or the elements 420-428 may include data from which one or more relationships to at least one other data element may be determined. For example, the 402-406 and/or the elements 420-428 may be associated with a timestamp. As another example, portions and/or elements may be associated with a variety of data, such as a location, a position, a color, a pitch, a frequency, a biometric aspect, or another aspect of the portion and/or element. The relationship between the two or more elements may include a comparative difference between the two or more elements, such as a time difference, a location difference, a positional difference, a color difference, a pitch difference, a frequency difference, a biometric difference, or another difference.

As another example, the elements 420-428 may have different positions or locations within a portion, or between different portions. The elements 420-428 may also be associated with a different time, as well as with different positions or locations, relative to two or more other elements. In some embodiments, three or more elements may define a relationship of one element to two or more other elements. For example, the position/location differences among elements 420, 422, and 424 may define three angles, angle A, angle B, and angle D. Similarly, the relative position/location and/or time differences among elements 420, 422, 424, 426, and 428 may define additional angles, angles C, E, F, G, H, I, and J. In various embodiments, a relationship may be a relative difference in time, space, distance, or another informational difference, within a portion, among or between portions, and/or within the data set 400.

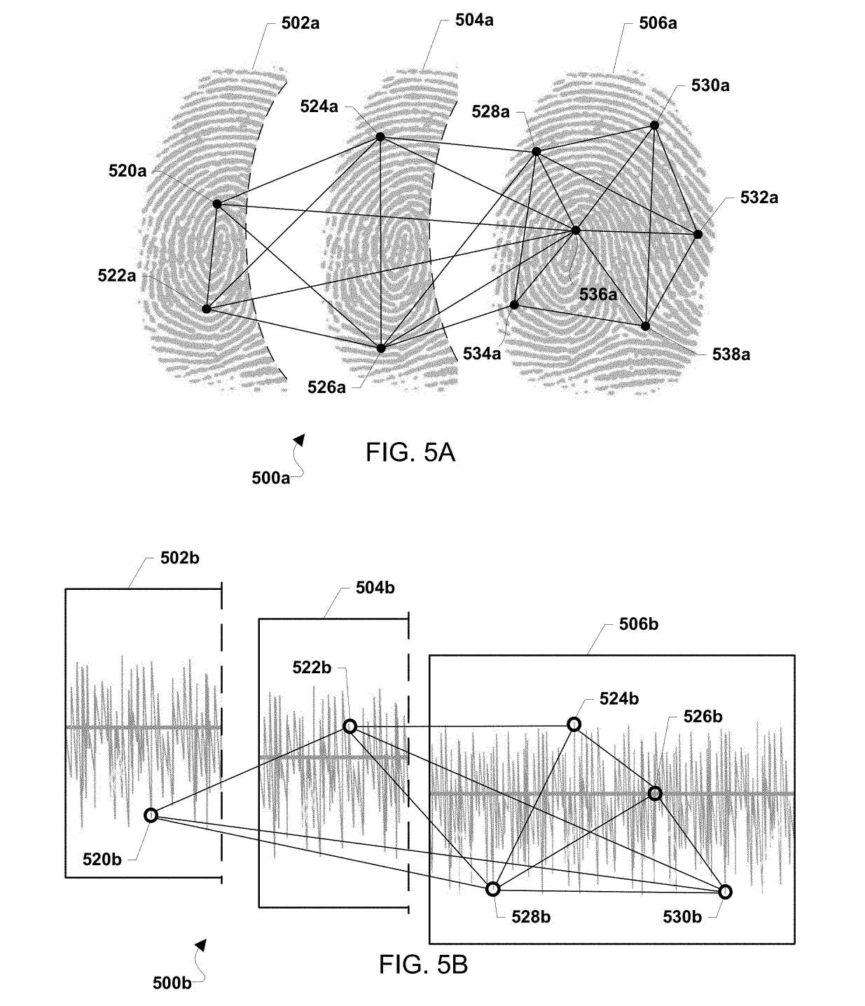

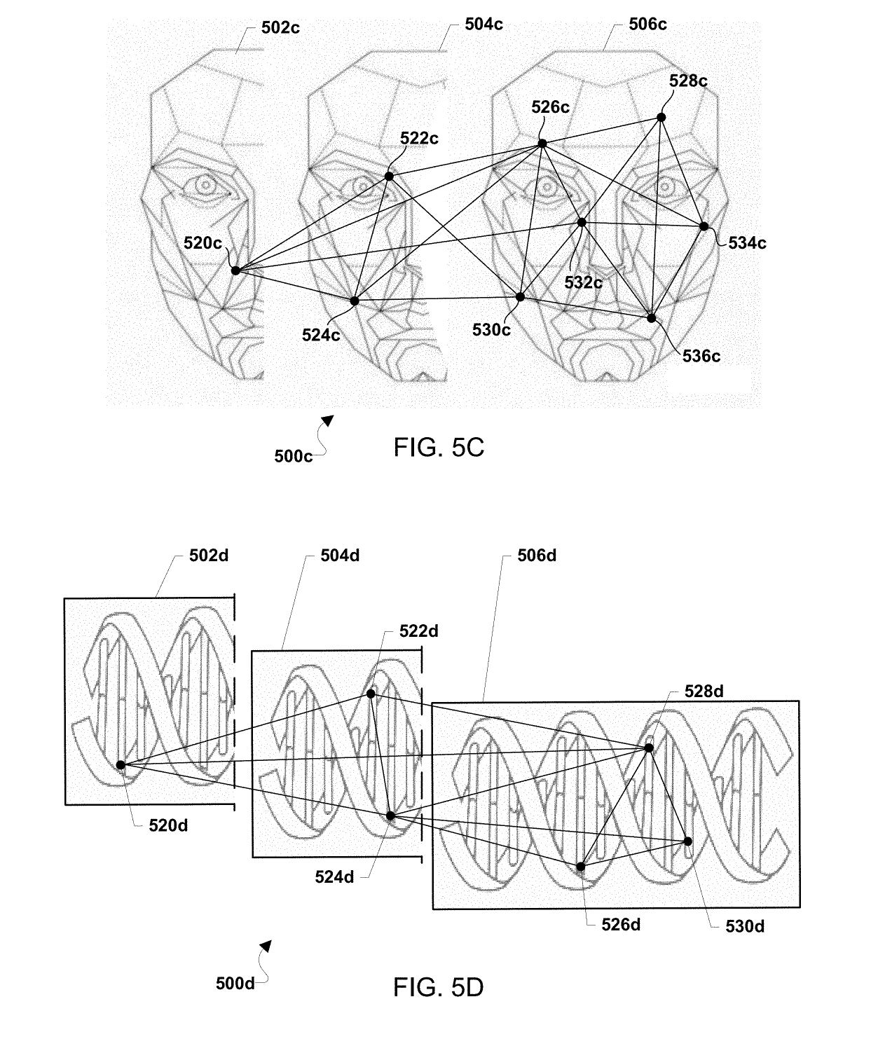

An ephemeral data set such as the ephemeral data set 400 may be made up of a wide variety of portions and/or elements. FIGS. 5A-5D illustrate ephemeral data sets 500a, 500b, 500c, and 500d. An ephemeral data set may include one or more of a variety of types of data, and the examples illustrated in FIGS. 5 and 5A-5D are intended to illustrate the variety of data types and not as limitations.

For example, the ephemeral data set 500a may include fingerprints 502a, 504a, and 505a. The fingerprints 502a-505a may be captured, for example, by a biometric scanning device such as a fingerprint scanner. The fingerprints 502a-506a may be captured over time, such that the fingerprints 502a-506a each constitute a portion of the data set 500a. A processor of a computing device (e.g., the computing devices 102-108) may select elements from the portions (e.g., the fingerprints 502a-506a) of the ephemeral data set 500a, such as elements 520a-538a. In some embodiments, the elements 520a-538a may include fingerprint minutiae. The elements 520a-538a may include information that enables a processor of a computing device to identify or index each element within a portion (e.g., within one of the fingerprints 502a-506a), such as information identifying a location or position of the element within its portion. Further, each portion may be associated with a timestamp or another time element.

The portions (e.g., the fingerprints 502a-506a) and/or the elements 520a-538a may include data from which one or more relationships to at least one other data element may be determined, such as position, location, and/or time information. In some embodiments, the portions and/or elements may include data from which one or more relationships among the elements may be determined. In some embodiments, the relationships may be based on one or more comparative differences between or among the elements.

As another example, the ephemeral data set 500b may include sound recordings 502b, 504b, and 506b. The sound recordings may be captured, for example, by a microphone or similar device, or the sound recordings may be received electronically by a processor of a computing device (e.g., the computing devices 102-108) from such a device. The sound recordings 502b-506b may be captured over time, and may include or be associated with time information. Each of the sound recordings 502b-506b may constitute a portion of the data set 500b. Additionally, or alternatively, a single recording (e.g., one of 502b, 504b, or 506b) may be divided into portions, for example, portions of a certain time duration, portions divided by frequency range, portions divided by amplitude ranges, and other divisions.

A processor of a computing device may select elements from the portions of the sound recordings 502b-506b, such as elements 520b-530b. The elements 520b-530b may include information that enables the identification or indexing of each element within a sound recording, such as information identifying a location or position of the element within its portion. Each element 520b-530b may be associated with timestamp or another time element and/or other information, such as frequency, a pitch, and amplitude, a rate of attack, a rate of decay, a duration of sustain.

The portions (e.g., the one or more sound recordings 502b) and/or the elements 520b-530b may include data from which one or more relationships to at least one other data element may be determined, such as position, location, and/or time information. In some embodiments, the portions and/or elements may include data from which the processor of a computing device may determine one or more relationships among the elements. In some embodiments, the relationships may be based on one or more comparative differences between or among the elements.

As another example, the ephemeral data set 500c may include images 502c, 504c, and 506c. The images 502c-506c may be of, for example, a face as illustrated in FIG. 5C, but in various embodiments the images 502a-506c may be any images. The images 502a-506c may be captured, for example, by a camera or another image receiving device. The images 502a-506c may be captured over time, such that the images 502a-506c each constitute a portion of the data set 500a. A processor of a computing device (e.g., the computing devices 102-108) may select elements from the portions (e.g., the images 502a-506c) of the data set 500c, such as elements 520c-536c. For example, the processor of the computing device may select the elements 520c-536c using a facial recognition or other similar system. The elements 520c-536c may include information that enables a processor of a computing device to identify or index each element within a portion (e.g., within one of the images 502a-506c), such as information identifying a location or position of the element within its portion. Further, each portion may be associated with a timestamp or another time element.

The portions (e.g., the images 502a-506c) and/or the elements 520c-536c may include data from which one or more relationships to at least one other data element may be determined, such as position, location, and/or time information. In some embodiments, the elements 520c-536c may be associated with image information, such as color, tint, hue, grayscale, RGB information, Pantone color number, digital color code (e.g., hypertext markup language color code), saturation, brightness, contrast, or other image information. In some embodiments, the portions and/or elements may include data from which one or more relationships among the elements may be determined. In some embodiments, the relationships may be based on one or more comparative differences between or among the elements. In some embodiments, the comparative differences may include differences in image information, including relative, linear, and/or numerical differences in information indicating color, tint, hue, etc.

As another example, the ephemeral data set 500d may include one or more biometric data units or constituents, such as DNA samples 502d, 504d, and 506d. Biometric data may be captured by an appropriate scanner or capture device and received by a processor of a computing device (e.g., the computing devices 102-108). The biometric data may be captured over time, and may include or be associated with time information. The ephemeral data set 500d may include two or more biometric data constituents or units, each of which may constitute a portion of the data set (e.g., two or more discrete biometric samples). Additionally or alternatively, a biometric sample may be divided into portions, which divisions may be determined based on the information available in the biometric sample. For example, the DNA samples 502d, 504d, and 506d may be divided into portions of a certain base-pair length or number, a certain length of the DNA backbone, by type of nucleotide (e.g., adenine, guanine, cytosine, or thymine), by type of base pair (e.g., adenine-thymine, cytosine-guanine), or another division.

A processor of a computing device may select elements from the portions of the biometric data unit 500d, such as elements 520d-530d. The elements 520d-530d may include information that enables the identification or indexing of each element within a biometric data, such as information identifying a location or position of the element within its portion, such as a position along the DNA strand 502d. Each element 520d-530d may be associated with timestamp or another time element.

The portions (e.g., the one or more biometric data units 502d) and/or the elements 520d-530d may include data from which one or more relationships to at least one other data element may be determined, such as position, location, and/or time information. In some embodiments, the portions and/or elements may include data from which the processor of a computing device may determine one or more relationships among the elements. In some embodiments, the relationships may be based on one or more comparative differences between or among the elements.

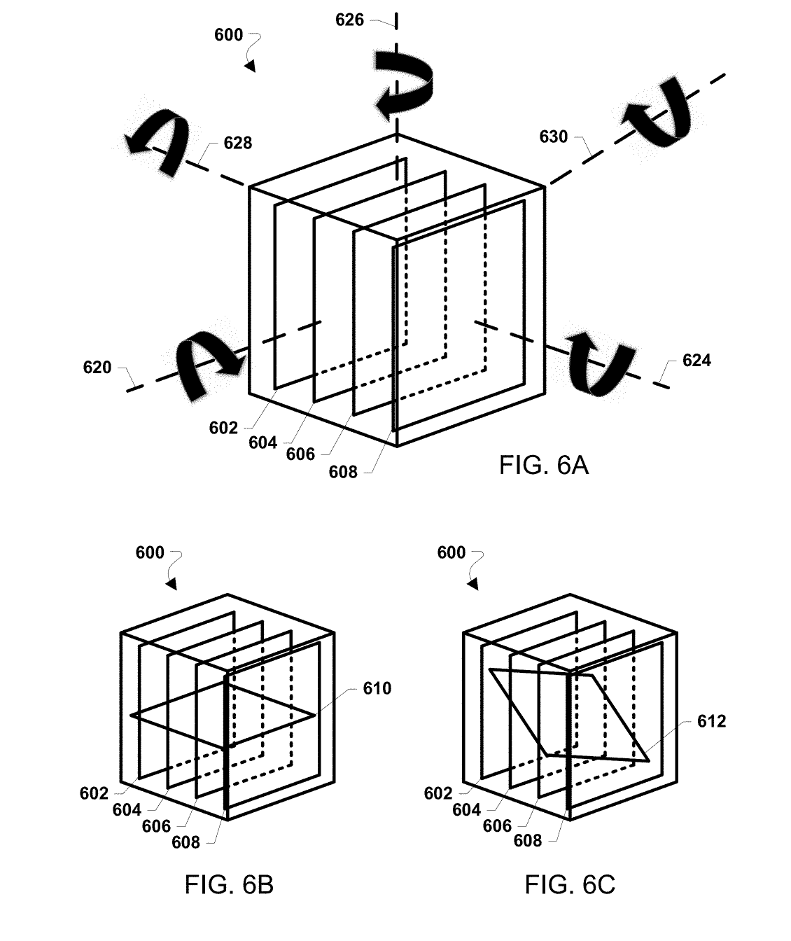

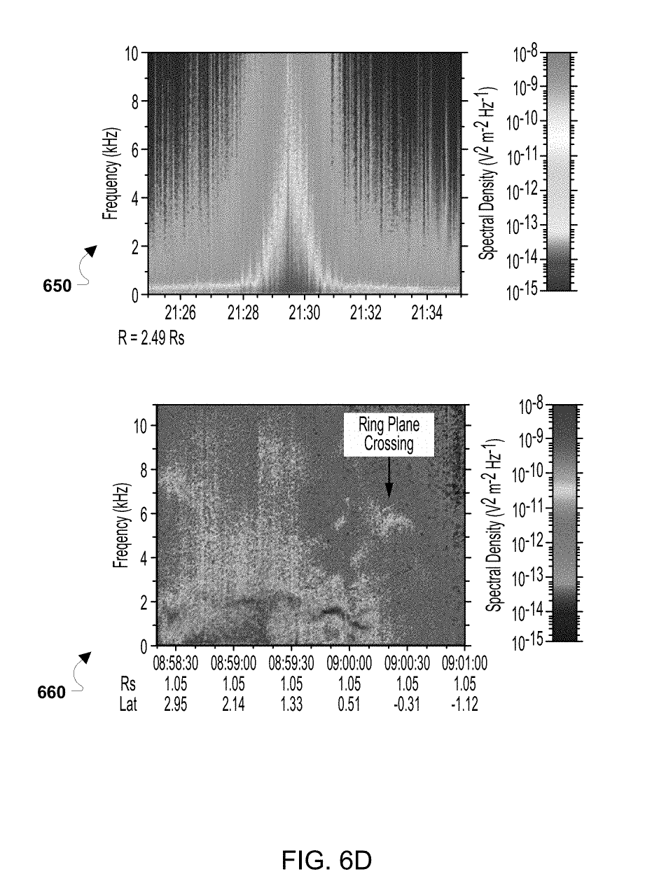

FIGS. 6A-6C illustrate representations of methods of managing an ephemeral data set according to various embodiments. With reference to FIGS. 1-6C, an ephemeral data set 600 may include two or more portions 602, 606, 606, and 608. The portions 602-608 may include data elements (e.g., the elements 420-428, 520a-538a, 520b-530b, 520c-536c, and 520d-530d). Further, the portions 602, 606, 606, and 608 may be associated with different times (e.g., were obtained at different times, or are associated with different time stamp information).

A processor (e.g., the processor 202 and/or the like) of a computing device (e.g., the computing devices 102 and 106 and the network element 110) may perform a transform on the ephemeral data set 600 to change one or more values of the data elements in the data set. As one example, the portions 602, 606, 606, and 608 may be image files. The processor may rotate the ephemeral data set 600, or any of the portions 602-608, along one or more axes 620, 624, and 626. The processor may also rotate the ephemeral data set 600 along an edge 628. The processor may also rotate the ephemeral data set 600 along an axis 630 extending from a “corner” of the data set to a “center” of the data set. Any of the rotations may alter one or more values of elements of the portions 602-608. The rotation(s) may also alter one or more relationships among the values of elements of the portions 602-608. By performing a transform on the ephemeral data set 600, the processor may generate a large number of changes to the values of the data elements of each of the portions 602-608. The changed values may provide a large number of highly unpredictable values from even a relatively small data set.

In some embodiments, the processor may add a new portion to, or may modify a portion present in, the ephemeral data set 600. In some embodiments, the processor may add or modify a portion so that relationships between the elements of the added/modify portion and other portions of the data set are irregular and thus difficult to predict. For example, in some embodiments, the processor may add or modify the portion so that the added/modify portion has a different relative orientation or other relationship to other portions of the data set. For example, the processor may add portion 610 to the ephemeral data set 600 in an orientation that is, for example, perpendicular to the portions 602-608. As another example, the processor may add portion 612 to the ephemeral data set 600 an orientation that is at an acute angle to the portions 602-608. The irregular, unpredictable relationships among data elements of the portions 602-612 may provide a large number of highly unpredictable values from even a relatively small data set.

As noted above, transforming an element and/or a portion may include performing one or more operations to alter one or more values of the element and/or portion. For example, transforming an element and/or a portion of an image or a video file may include rotating, flipping, inverting, shifting a position, shifting a color, applying a filter or preset transformation (e.g., as may be available in a photo or video editing software program), or another similar operation. As another example, transforming an element and/or a portion of a music or audio file may include raising or lowering pitches, reversing the content of the file, inverting the content of the audio file (i.e., transforming the content along a selected axis), adding an audio effect such as reverb, distortion, flanging, and the like, or another similar operation. As another example, transforming an element and/or a portion of the ephemeral shared data set may include transcoding data elements (e.g., transforming audio data into visual data or text). As another example, transforming an element and/or a portion of the ephemeral shared data set may include performing one or more mathematical functions to transform the element and/or portion. As another example, transforming an element and/or a portion of the ephemeral shared data set may include changing a size or shape, distorting a share, performing a skew, a stretch, or another dimensional change on an element and/or portion of the data set. As noted above, transforming an element and/or portion of the data set may change not only a value of the element and/or portion, they may also change one or more relationships of the transformed element and/or portion to other elements and/or portions of the data set.

As another example, transforming an element and/or a portion of a data set (e.g., the ephemeral data set 600) may include performing one or more operations to transcode data elements from one data format or type to another data format or type. FIG. 6D illustrates two representations 650 and 660 of a transformation of a first data format or type to a second data format or type. Representations 650 and 660 illustrate transformations of audio data into visual data, specifically spectrograms of data collected by the NASA Cassini spacecraft as it crossed the plane of Saturn's rings. The spectrograms 650 and 660 illustrate a transformation of audio data into visual data. This is merely one example, and in various embodiments, any data format or type may be transformed into another data format or type.

In various embodiments, performing one or more transformations to the ephemeral data set 600 enables the processor to generate a very large number of unpredictable element values and relationships among data elements from a relatively small number of portions. For example, in a case in which the portions 602-612 represent image files, each image file may include a large number of pixels, and each pixel may be associated with a number of different values, such as location information within the image file, color, hue, saturation, black and white value, and other such pixel information. Even without transformation, each image file of a series image files may contain a unique set of information. For example, each image in a series of images captured from a camera aimed at a highway will include a unique selection of vehicles, at different positions on the road, with different environmental conditions (e.g., cloud formations, sunlight, darkness, solar glare, shadows, etc.). The processor then may perform the transform on one or more of the image files, thereby changing not only the values of the various pixels in the transformed image files, but also numerous relationships among the data elements of the transformed image files and other portions of the data set.

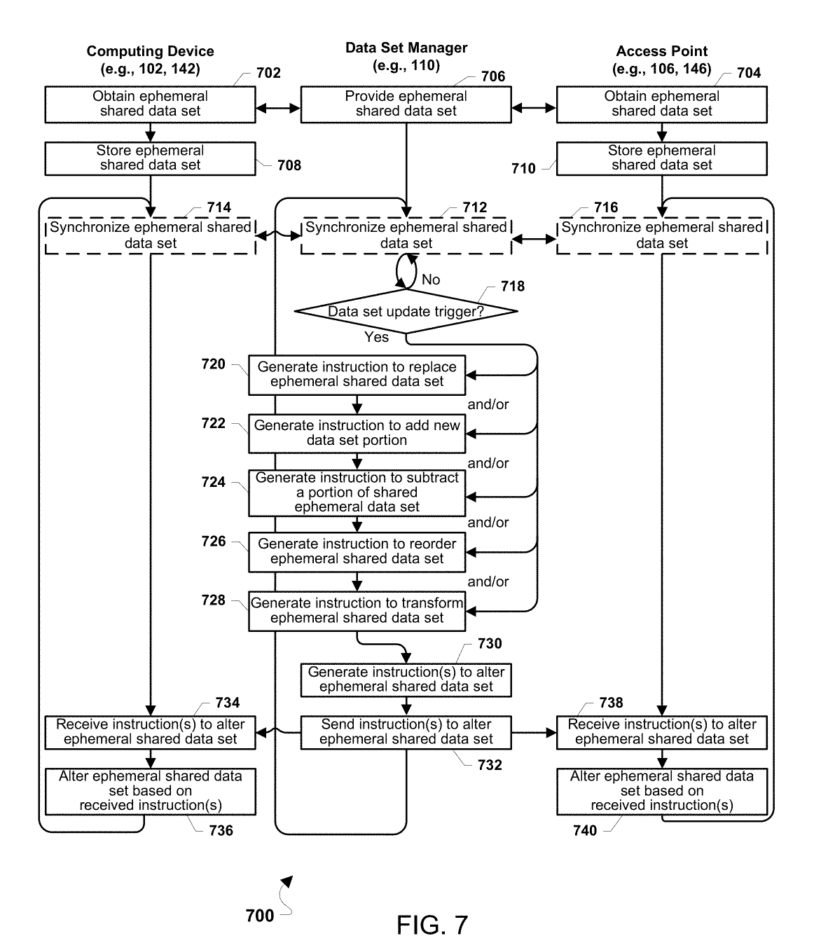

FIG. 7 illustrates a method 700 of managing synchronization of an ephemeral shared data set according to various embodiments. With reference to FIGS. 1A-7, the method 700 may be implemented by a processor (e.g., the processor 202 or the like) of a computing device (e.g., the computing devices 102 and 142), an access point (e.g., the access points 106 and 146), and/or a data set manager (e.g., the network element 110). In various embodiments, the dynamic (e.g., ephemeral) shared data set may exist in one state for a relatively short period of time, which may be, for example, minutes or seconds. The relatively short duration and the inherent complexity of any state of the dynamic shared data set reduces by orders of magnitude the possibility of such information being guessed, accessed, or “hacked” and then used as a means of attacking the system.

In block 702, a processor of a computing device may obtain an ephemeral shared data set. In block 704, a processor of the access point may obtain the ephemeral shared data set. In various embodiments, the operations of blocks 702 and 704 may enable the computing device and the access point to be provisioned with the ephemeral shared data set.

In block 706, a processor of a data set manager may provide the ephemeral shared data set to the computing device and the access point. In some embodiments, the ephemeral shared data set may include some or all of a data set stored at and managed by the data set manager (e.g., the ephemeral data set 400, 500a, 500b, 50c, 500d, and 600).

In block 708, the processor of the computing device may store the ephemeral shared data set (e.g., in the storage 104). In block 710, the processor of the access point may store the ephemeral shared data set (e.g., in the storage 108).

In optional block 712, the processor of the data set manager may perform one or more operations to synchronize the ephemeral shared data set. In optional block 714, the processor of the computing device may perform one or more operations to synchronize the ephemeral shared data set. In optional block 716, the processor of the access point may perform one or more operations to synchronize the ephemeral shared data set. In various embodiments, the synchronization operations of blocks 712, 714, and 716 may be initiated by the data set manager, the computing device, or the access point. The synchronization operations of block 712, 714, and 716 may include the transmission and/or exchange of one or more messages indicating the status and/or state of the ephemeral shared data set stored at each of the data set manager, the computing device, and the access point. The synchronization operations of blocks 712, 714, and 716 may include performing by the processor of the data set manager, the computing device, and the access point, one or more analyses of their respective stored ephemeral shared data sets, such as a determining a checksum, performing a hash, and the like.

In determination block 718, the processor of the data set manager may determine whether a data set update trigger has occurred. For example, the processor may determine whether a period of time has elapsed. As another example, the processor may determine whether a trigger event has occurred. The trigger event may include, for example, using an ephemeral shared data set in an authentication process, such as extracting element(s) from ephemeral shared data set, determining a value from the element(s), etc., as further described below. In some embodiments, the trigger event may include, for example, using an ephemeral shared data set in an encryption process, as further described below. The trigger event may include, for example, a request from one or more computing devices to update the ephemeral shared data set.

In response to determining that the data set update trigger has not occurred (i.e., determination block 718=“No”), the processor of the data set manager may again perform operations to synchronize the ephemeral shared data set in optional block 712. The processors of the computing device and the access point may also perform operations to synchronize the ephemeral shared data set in optional block 714 and 716, respectively.

In response to determining that the data set update trigger has occurred (i.e., determination block 718=“Yes”), the processor may perform one or more operations to dynamically alter the ephemeral shared data set.

For example, the processor of the data set manager may generate an instruction to replace the ephemeral shared data set in block 720. In some embodiments, the processor of the data set manager may determine the replacement (new) data set. In some embodiments, the replacement data set may include one or more portions of the data set managed by the data set manager.

Additionally or alternatively, the processor of the data set manager may generate an instruction to add a new data set portion in block 722. In some embodiments, the new data set portion may be based on received data inputs (e.g., the data inputs 130). In some embodiments, the processor of the data set manager may generate the new data set portion to be added. In some embodiments, the generated instructions may include instructions enabling the generation of the new data set portion (which may, e.g. be sent to the computing device and the access point, as described below).

Additionally or alternatively, the processor of the data set manager may generate an instruction to subtract a portion of the ephemeral shared data set in block 724.

Additionally or alternatively, the processor may generate an instruction to reorder the ephemeral shared data set in block 726. For example, reordering the ephemeral shared data set may include placing one or more portions of the ephemeral shared data set into a different time, location, position, or other difference relative to other portions of the ephemeral shared data set.

Additionally or alternatively, the processor may generate an instruction to transform the ephemeral shared data set in block 728. For example, the processor may generate an instruction to transform one or more elements and/or one or more portions of the ephemeral shared data set. In various embodiments, transforming a portion and/or an element of the ephemeral shared data set portion may include performing one or more operations to alter one or more values of the element and/or portion. For example, transforming an element and/or a portion of an image or a video file may include rotating, flipping, inverting, shifting a position, shifting a color, applying a filter or preset transformation (e.g., as may be available in a photo or video editing software program), or another similar operation. As another example, transforming an element and/or a portion of a music or audio file may include raising or lowering pitches, reversing the content of the file, inverting the content of the audio file (i.e., transforming the content along a selected axis), adding an audio effect such as reverb, distortion, flanging, and the like, or another similar operation. As another example, transforming an element and/or a portion of the ephemeral shared data set may include transcoding data elements (e.g., transforming audio data into visual data or text). As another example, transforming an element and/or a portion of the ephemeral shared data set may include performing one or more mathematical functions to transform the element and/or portion.

In block 730, the processor may generate one or more instructions to alter the ephemeral shared data set. The one or more instructions may be based on the instruction to replace the ephemeral shared data set, the instruction to add a new data set portion (and/or the generated new data set portion), the instruction to subtract a portion of the ephemeral shared data set, the instruction to re-order the ephemeral shared data set, and/or the instruction to transform the ephemeral shared data set.

In block 732, the processor of the data set manager may send the one or more instructions to alter the ephemeral shared data set to the computing device and the access point.

In block 734, the processor of the computing device may receive the one or more instructions to alter the ephemeral shared data set.

In block 736, the processor of the computing device may alter its stored copy of the ephemeral shared data set based on the received one or more instructions.

In block 738, the processor of the access point may receive the one or more instructions to alter the ephemeral shared data set.

In block 740, the processor of the access point may alter its stored copy of the ephemeral shared data set based on the received one or more instructions.

The processors of the data set manager, the computing device, and the access point may then perform operations to synchronize the ephemeral shared data set, in optional block 712, 714, and 716, respectively.

In some embodiments, a computing device and/or an access point may determine that its ephemeral shared data set is out of synchronization, and the computing device and/or the access point may perform operations to synchronize its stored ephemeral shared data set. For example, the computing device and/or access point may lose network connectivity for a period of time, maybe powered off, or may otherwise be out of or beyond network communication. In some embodiments, the data set manager may store one or more previous instructions to alter the ephemeral shared data set. In some embodiments, synchronization operations performed by a computing device and/or access point may include determining that the computing device and/or access point has not performed one or more instructions to alter its stored ephemeral shared data set. For example, the computing device and/or access point may exchange one or more synchronization messages with the data set manager when the computing device and/or access point reestablishes a communication link with the communication network, and based on information in the one or more synchronization messages the computing device and/or access point may determine that its stored version of the ephemeral shared data set is out of synchronization. In some embodiments, the computing device and/or access point may request that the data set manager send to the computing device and/or access point the unperformed instructions to alter the ephemeral shared data set. The computing device and/or access point may then perform the received and as-yet unperformed instructions to alter its version of the ephemeral shared data set, to bring the ephemeral shared data set stored at the computing device and/or access point into synchronization.

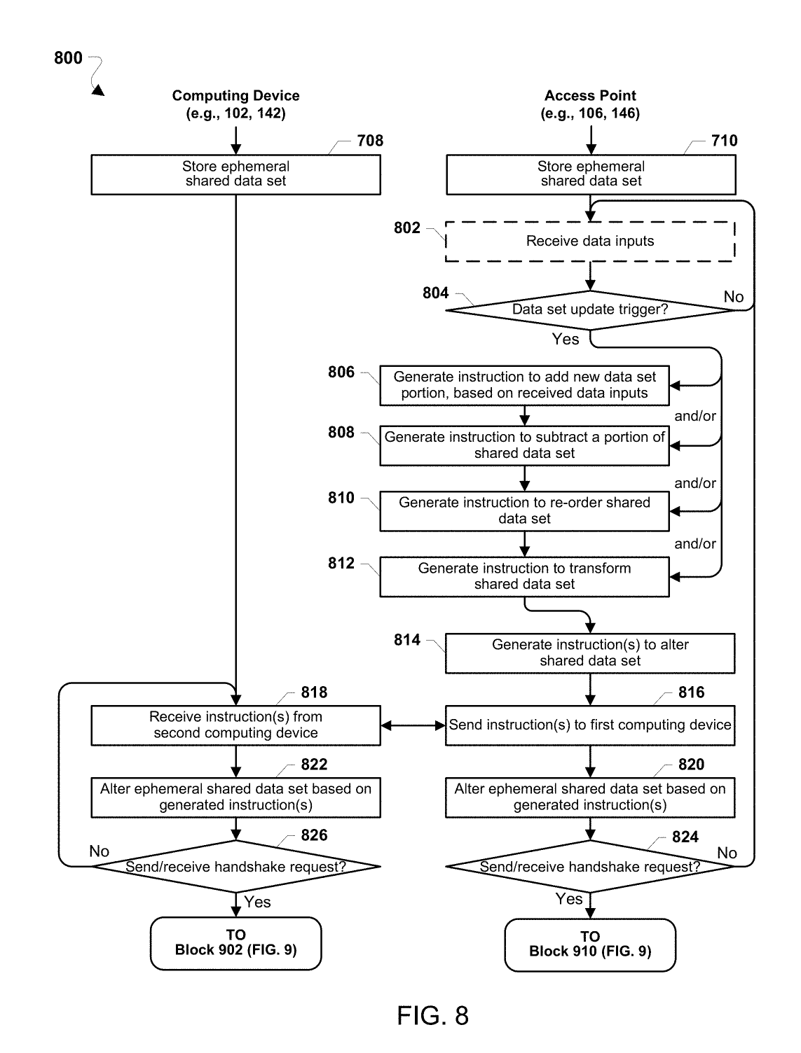

FIG. 8 illustrates a method 800 of dynamically altering an ephemeral shared data set according to some embodiments. With reference to FIGS. 1A-8, the method 800 may be implemented by a processor (e.g., the processor 202 and/or the like) of a computing device (e.g., the computing devices 102 and 142) and/or an access point (e.g., the access points 106 and 146).

Various embodiments enhance and improve the verification of a computing device and an access point by utilizing a dynamically changing shared information context. The information context may include, for example, a dynamically changing shared data set. The dynamically changing shared information context may be a unique data set shared only by the computing device and the access point. As described above, the ephemeral shared data set may be compiled over time, and may be changed occasionally, periodically, and/or upon the occurrence of a triggering event. Changing or altering the shared data set may include reordering the shared data set, adding information to the shared data set, subtracting information from the shared data set, and/or transforming one or more portions of the shared data set.

The description of the method 800 below describes the computing device processor performing and the access point processor each performing certain operations. However, in various embodiments, the roles of the computing device and the access point may be reversed, and the computing device processor may perform the operations described below as being performed by the access point processor, and vice versa.

In blocks 708 and 710, the computing device and the access point may each store an ephemeral shared data set, as described.

In optional block 802, the access point processor may receive data inputs. For example, the processor of CD2 may receive data inputs (e.g., the data inputs 130) over time. The data inputs may include information that the processor of the computing device may use to generate a data set that may be shared with another computing device. The data inputs may include, for example, images, photographs, video, sound recordings (e.g., music, ambient sound recordings, or another such recording), biometric information inputs (e.g., facial recognition scans, iris scans, DNA samples, voiceprint recordings, fingerprints, and the like), or any other data input.

In determination block 804, the access point processor may determine whether a shared data set update trigger has occurred. For example, the access point processor may determine whether a period of time has elapsed. As another example, the access point processor may determine whether a trigger event has occurred. The trigger event may include, for example, using a shared data set in an authentication process, such as extracting element(s) from shared data set, determining a value from the element(s), etc., as further described below. The trigger event may include, for example, a request from one or more computing devices to update the shared data set. The trigger event may include, for example, an authorization failure, or an authorization success, of a computing device.

In response to determining that the data set update trigger has not occurred (i.e., determination block 804=“No”), the access point processor may continue to receive data inputs in optional block 802.

In response to determining that the data set update trigger has occurred (i.e., determination block 804=“Yes”), the access point processor may perform one or more operations to dynamically alter the shared data set.

For example, in block 806, the access point processor may generate an instruction to add a new data set portion based on the received data inputs. In some embodiments, the access point processor may generate the new data set portion to be added. In some embodiments, the generated instructions may include instructions enabling the generation of the new data set portion (which may, e.g. be sent to the second computing device, as described below).

Additionally or alternatively, the access point processor may generate an instruction to subtract a portion of the shared data set in block 808.

Additionally or alternatively, the access point processor may generate an instruction to re-order the shared data set in block 810. For example, reordering the shared data set may include placing one or more portions of the shared data set into a different time, location, position, or other difference relative to other portions of the shared data set.

Additionally or alternatively, the access point processor may generate an instruction to transform the shared data set in block 812. For example, the access point processor may generate an instruction to transform one or more elements and/or one or more portions of the shared data set.

Transforming an element and/or a portion may include performing one or more operations to alter one or more values of the element and/or portion. For example, transforming an element and/or a portion of an image or a video file may include rotating, flipping, inverting, shifting a position, shifting a color, applying a filter or preset transformation (e.g., as may be available in a photo or video editing software program), or another similar operation. As another example, transforming an element and/or a portion of a music or audio file may include raising or lowering pitches, reversing the content of the file, inverting the content of the audio file (i.e., transforming the content along a selected axis), adding an audio effect such as reverb, distortion, flanging, and the like, or another similar operation. As another example, transforming an element and/or a portion of the shared data set may include transcoding data elements (e.g., transforming audio data into visual data or text). As another example, transforming an element and/or a portion of the shared data set may include performing one or more mathematical functions to transform the element and/or portion.

In block 814, the access point processor may generate one or more instructions to alter the shared data set. The one or more instructions may be based on the generated new data set portion, the instruction to subtract a portion of the shared data set, and/or the instruction to re-order the shared data set.

In block 816, the access point processor may send the one or more instructions to the computing device. In some embodiments, the generated instructions may include a newly generated data set portion (e.g., as may be generated in block 806).

In block 818, the computing device processor may receive the one or more instructions from the second computing device.

In block 820, the access point processor may alter its ephemeral shared data set based on the generated instruction or instructions.

In block 822, the computing device processor may alter its ephemeral shared data set based on the generated instruction or instructions.

In determination block 824, the access point processor may determine whether a handshake request has been sent or received by the access point processor.

In response to determining that a handshake request has not been sent or received (i.e., determination block 824=“No”), the access point processor may continue to receive data inputs in optional block 802, or may determine whether a data set update trigger has occurred in determination block 804.

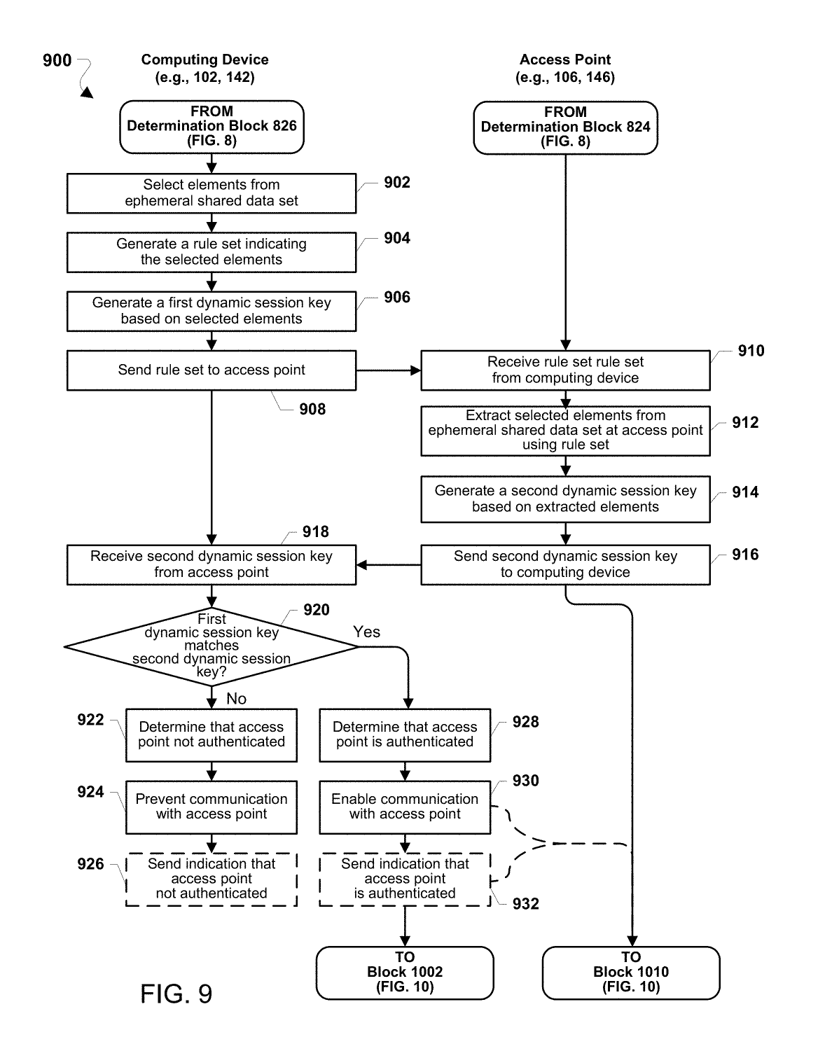

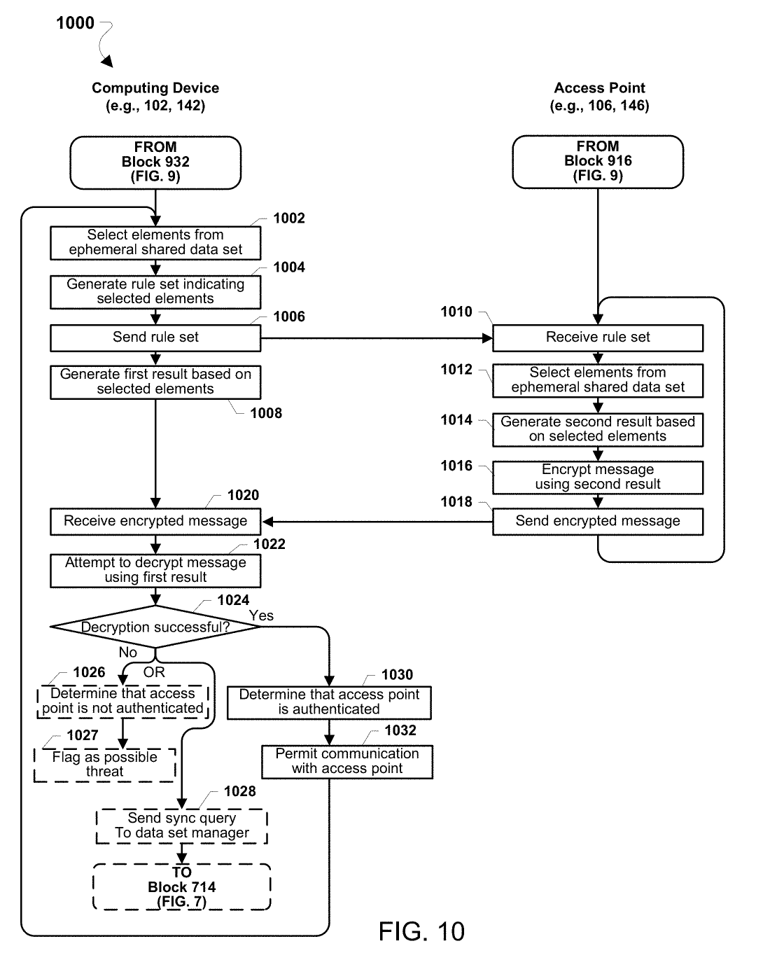

In response to determining that the handshake request has been sent or received (i.e., determination block 824=“Yes”), the access point processor may proceed to block 910 in FIG. 9.

In determination block 826, the computing device processor may determine whether a handshake request has been sent or received by the computing device processor.

In response to determining that a handshake request has not been sent or received (i.e., determination block 826=“No”), the computing device processor may again receive one or more instructions from the second computing device in block 818.

In response to determining that a handshake request has been sent or received (i.e., determination block 826=“Yes”), the processor of the first computing device may proceed to block 902 in FIG. 9.

FIG. 9 illustrates a method 900 of performing a dynamic session handshake utilizing an ephemeral shared data set according to some embodiments. With reference to FIGS. 1A-9, in some embodiments, the dynamic session handshake may be performed between the computing device (e.g., the computing device 102, 142) and an access point (e.g., the access point 106, 146). In some embodiments, the method 900 may be implemented by a processor (e.g., the processor 202 or the like) of a computing device (e.g., the computing devices 102 and 142) and/or an access point (e.g., the access points 106 and 146). Various embodiments enhance and improve the verification of a computing device and an access point by performing a dynamic session handshake utilizing a dynamically changing shared information context (e.g., a dynamically changing shared data set).

The description of the method 900 below describes the computing device processor performing and the access point processor each performing certain operations. However, in various embodiments, the roles of the computing device and the access point may be reversed, and the computing device processor may perform the operations described below as being performed by the access point processor, and vice versa.

In block 902, the computing device processor may select elements from the ephemeral shared data set. For example, the computing device processor may select elements 420, 422, 424, and 428 from among the portions 402, 404, and 406 of the shared data set 400. As another example, the computing device processor may select elements from among the shared data sets 500a, 500b, 500c, 500d, and 600. In some embodiments, the computing device processor may select the elements randomly from the shared data set.

In block 904, the computing device processor may generate a rule set indicating the selected elements. In some embodiments, the rule set may identify the selected elements from the shared data set. For example, the computing device processor may generate a rule set identifying the elements selected from the shared data set.

In some embodiments, the computing device processor may generate the rule set based on the one or more relationships between or among the selected elements of the shared data set. The relationship between the two or more elements may include a comparative difference between the two or more elements, such as a time difference, a location difference, a positional difference, a color difference, a pitch difference, a frequency difference, or another difference. As another example, the relationships may be defined by comparative differences among three or more elements. For example, the position/location differences among the elements 420, 422, and 424 may define three angles, angle A, angle B, and angle D. Similarly, the relative position/location and/or time differences among elements 420, 422, 424, 426, and 428 may define additional angles, angles C, E, F, G, H, I, and J. In some embodiments, the computing device processor may generate the rule set based on one or more relationships among the selected elements of, for example, the shared data sets 500a, 500b, 500c, 500d, or 600. In various embodiments, a relationship may be a relative difference in time, space, distance within a portion, or another informational difference. The relationship(s) between or among elements may be determined among and/or between portions of the shared data set.

In some embodiments, the computing device processor may generate the rule set using a combination of identifiers of the selected elements and one or more relationships among the selected elements. In some embodiments, the rule set may include an identifier of only one of the selected elements and relationships of the one selected element and the other selected elements. For example, the rule set may include an identifier of the element 420, and information about the relationships of the element 420 to the other selected elements (elements 422-428) sufficient to enable another computing device to identify the other selected elements (elements 422-428) using only the element 420 and the information about the relationships of the element 420 and the other selected elements. In some embodiments, the processor may generate a rule set using a combination of identifiers of the selected elements and one or more relationships among the selected elements of, for example, the shared data sets 500a, 500b, 500c, 500d, or 600.

In some embodiments, the generated rule set may be formatted as a string of information organized according to an organizational logic. The more efficient the organizational logic, the smaller the generated rule set may be, enabling faster generation, transmission, and processing by receiving computing device, thereby decreasing a burden on processors of the computing devices as well as the transport infrastructure.

In block 906, the computing device processor may generate a first result based on the selected elements. In some embodiments, the first result may include a string of data. In some embodiments, the first result may include a value based on the information in the selected elements of the shared data set. In some embodiments, the processor of the first computing device may perform a transform of the information of the selected elements, such as generating a hash of values within the information. In some embodiments, the processor of the first computing device may generate a data string based on the information of the selected elements and may perform a transform (e.g., generate a hash) of the information of the selected elements to generate the first result.

In block 908, the computing device processor may send the rule set to the access point (e.g., 106, 146). In some embodiments, the computing device may send a verification request including the rule set to the access point.

In block 910, the processor of the access point may receive the rule set (or verification request) from the first computing device.

In block 912, the access point processor may extract the selected elements from the shared data set stored at the access point using the rule set. For example, the access point processor may use identifiers of each of the selected elements 420-428 to extract the selected elements from the shared data set stored at the access point. As another example, the access point processor may use one or more identifiers of one of the selected elements (e.g., one or more of the elements 420-428, or one or more of the elements of the shared data set 500a, 500b, 500c, 500d, or 600) and one or more relationships among the selected elements to extract the selected elements from the shared data set.

In block 914, the access point processor may generate a second dynamic session key based on the selected elements. In some embodiments, the second dynamic session key may include a string of data. In some embodiments, the second dynamic session key may include a value based on the information in the selected elements of the shared data set. In some embodiments, the access point processor may perform a transform of the information of the selected elements, such as generating a hash of values within the information. In some embodiments, the access point processor may generate a data string based on the information of the selected elements and may perform a transform (e.g., generate a hash) of the information of the selected elements to generate the first result. In various embodiments, the access point processor may use the same method of generating the second result that the computing device uses to generate the first dynamic session key.

In block 916, the access point processor may send the second dynamic session key to the computing device.

In block 918, the computing device processor may receive the second dynamic session key from the access point.

In determination block 920, the computing device processor may determine whether the first dynamic session key matches the second dynamic session key. For example, the processor may determine whether a product of the first dynamic session key and the second dynamic session key equals zero. As another example, the processor may compare the first dynamic session key and the second dynamic session key. In response to determining that the first dynamic session key does not match the second dynamic session key (i.e., determination block 920=“No”), the computing device processor may determine that the access point is not authenticated in block 922.

In block 924, the computing device processor may prevent the computing device from communicating with the access point.

In optional block 926, the computing device processor may send an indication that the access point is not authenticated. For example, the computing device may send the indication to the access point. As another example, the computing device may send the indication to another computing device (e.g., the computing device 110).

In response to determining that the first dynamic session key matches the second dynamic session key (i.e., determination block 920=“Yes”), the computing device processor may determine that the access point is authenticated in block 928.

In block 930, the computing device processor may enable communications with the access point.

In optional block 932, the computing device processor may send an indication that the access point is authenticated. For example, the computing device may send the indication to the access point. As another example, the computing device may send the indication to another computing device (e.g., the computing device 110).

The processor of the computing device may then proceed to the operations of block 1002 illustrated in FIG. 10.

In some embodiments, if the computing device processor enables communication with the access point (e.g., block 930), the access point processor may then proceed to the operations of block 1010 (FIG. 10). In some embodiments, if the computing device processor sends an indication that the access point is authenticated (e.g., block 932), the access point processor may then proceed to the operations of block 1010 illustrated in FIG. 10.

FIG. 10 illustrates a method 1000 for protecting a communication according to various embodiments. With reference to FIGS. 1A-10, the method 1000 may be implemented may be implemented by a processor (e.g., the processor 202 and/or the like) of a computing device (e.g., the computing devices 102 and 142) and/or an access point (e.g., the access points 106 and 146).

Various embodiments protect communications between the computing device and the access point by utilizing a dynamically changing encryption based on a dynamically changing shared information context. The information context may include, for example, a dynamically changing shared data set. The dynamically changing shared information context may be a unique data set shared only by the computing device and the access point. As described above, the ephemeral shared data set may be compiled over time, and may be changed occasionally, periodically, and/or upon the occurrence of a triggering event. Changing or altering the shared data set may include reordering the shared data set, adding information to the shared data set, subtracting information from the shared data set, and/or transforming one or more portions of the shared data set.

The description of the method 1000 below describes the computing device processor performing and the access point processor each performing certain operations. However, in various embodiments, the roles of the computing device and the access point may be reversed, and the computing device processor may perform the operations described below as being performed by the access point processor, and vice versa.

In block 1002, the computing device processor may select elements from the ephemeral shared data set. For example, the computing device processor may select elements 420, 422, 424, and 428 from among the portions 402, 404, and 406 of the shared data set 400. As another example, the computing device processor may select elements from among the shared data sets 500a, 500b, 500c, 500d, and 600. In some embodiments, the computing device processor may select the elements randomly from the shared data set.

In block 1004, the computing device processor may generate a rule set indicating the selected elements. For example, the computing device processor may select one or more elements from one or more portions of the ephemeral shared data set, and may generate the rule set identifying the selected two or more elements. In some embodiments, the computing device processor may determine one or more relationships between the selected two or more elements, and may generate the rule set based on the determined one or more relationships between the selected two or more elements. In some embodiments, the relationship(s) may be based on one or more comparative or relational differences between or among the elements, such as those described above with respect to ephemeral shared data sets 400, 500a-500d, and 600. In some embodiments, the rule set may indicate a number system to be used in identifying and selecting elements from the shared data set, such as decimal, octal, hexadecimal, etc. In some embodiments, the rule set may indicate an encryption protocol to be used by the computing device and the access point. In various embodiments, the rule set may indicate two or more encryption protocols to be used, so that the encryption protocol employed by the computing device and the access point changes over time.

In block 1006, the computing device processor may send the rule set to the access point.

In block 1008, the computing device processor may generate a first result based on the selected elements.

In block 1010, a processor of the access point may receive the rule set from the computing device.

In block 1012, the access point processor may select elements from its stored version of the ephemeral shared data set using the rule set. For example, the access point processor may use identifiers of each of the selected elements (e.g., one or more of the elements 420-428, or one or more of the elements of the ephemeral shared data sets 500a-500d or 600) to select the elements from the ephemeral shared data set stored at the access point. As another example, the access point processor may use one or more identifiers of one of the elements and one or more relationships among the selected elements to select the elements from the ephemeral shared data set.

In block 1014, the access point processor may generate a second result based on the selected elements. In some embodiments, the second result may include a string of data. In some embodiments, the second result may include a value based on the information in the selected elements of the shared data set. In some embodiments, the access point processor may perform a transform of the information of the selected elements, such as generating a hash of values within the information. In some embodiments, the access point processor may generate a data string based on the information of the selected elements and may perform a transform (e.g., generate a hash) of the information of the selected elements to generate the first result. In various embodiments, the access point processor may use the same method of generating the second result that the computing device processor uses to generate the first result.

In block 1016, the access point processor may encrypt a message using the second result. For example, the access point processor may use an encryption method such as MD5, SHA2, SHA256, BLAKE2, and the like, together with the second result to encrypt the message. In some embodiments, the message may serve as a test message to enable the computing device processor to determine whether the second result generated by the access point processor matches the first result generated by the computing device processor.

In block 1018, the access point processor may send the encrypted message to the computing device.

In block 1020, the computing device processor may receive the encrypted message.

In block 1022, the computing device processor may attempt to decrypt the message using the first result. For example, the computing device processor may initiate a decryption process of the message. In various embodiments, the computing device processor may use decryption format such as MD5, SHA2, SHA256, BLAKE2, and the like to attempt the decryption of the message.

In determination block 1024, the computing device processor may determine whether the decryption of the message from the access point was successful. In some embodiments, a successful decryption of the encrypted message from the access point may indicate that the first result and the second result match.

In response to determining that the decryption was not successful (i.e., determination block 1024=“No”), in some embodiments the computing device processor may determine that the access point is not authenticated in optional block 1026. In optional block 1027, the processor of CD1 may flag the access point as a possible threat. For example, the processor of CD1 may store an indication in memory that access point is a potential attacker or another threat to CD1 and/or the data set manager (e.g., a rogue access point, a device falsely purporting to be an access point, an intruder, or another suitable device).

In response to determining that the decryption was not successful (i.e., determination block 1024=“No”), in some embodiments the computing device processor may send a synchronization query to the data set manager in optional block 1028. In some embodiments, following the sending of the synchronization query, the computing device processor may attempt to synchronize its ephemeral shared data set. In some embodiments, following the sending of the synchronization query, the processors of the data set manager, the computing device, and the access point may perform operations to synchronize the shared data set, in optional block 712, 714, and 716, respectively.

In response to determining that the decryption was successful (i.e., determination block 1024=“Yes”), the computing device processor determine that the access point is authenticated in block 1030.

In block 1032, the computing device processor may thereafter permit (or continue to permit) communication with the access point.

In some embodiments, from time to time, the computing device processor may repeat the operations of blocks 1002-1032 to re-authenticate the access point.

In various embodiments, the access point processor may perform the operations of the method 1000 to authenticate the computing device. In some embodiments, the computing device and the access point may alternate roles, so that each of the computing device and the access point alternate performing operations to authenticate the other.

In various embodiments, the ephemeral shared data set may exist in one state for a relatively short period of time, which may be, for example, minutes, or seconds. In various embodiments, the dynamic value (e.g., the first value, the second value) may be usable to encrypt and decrypt only one communication. This contrasts with the effective duration of certificates from a conventional certifying authority (such as PM certificates), which may have a duration of up to decades in some cases. The relatively short useful duration and the inherent complexity of the ephemeral shared data set and the dynamic value reduces by orders of magnitude the possibility of such information being guessed, accessed, or “hacked” and then used as a means of attacking the system.

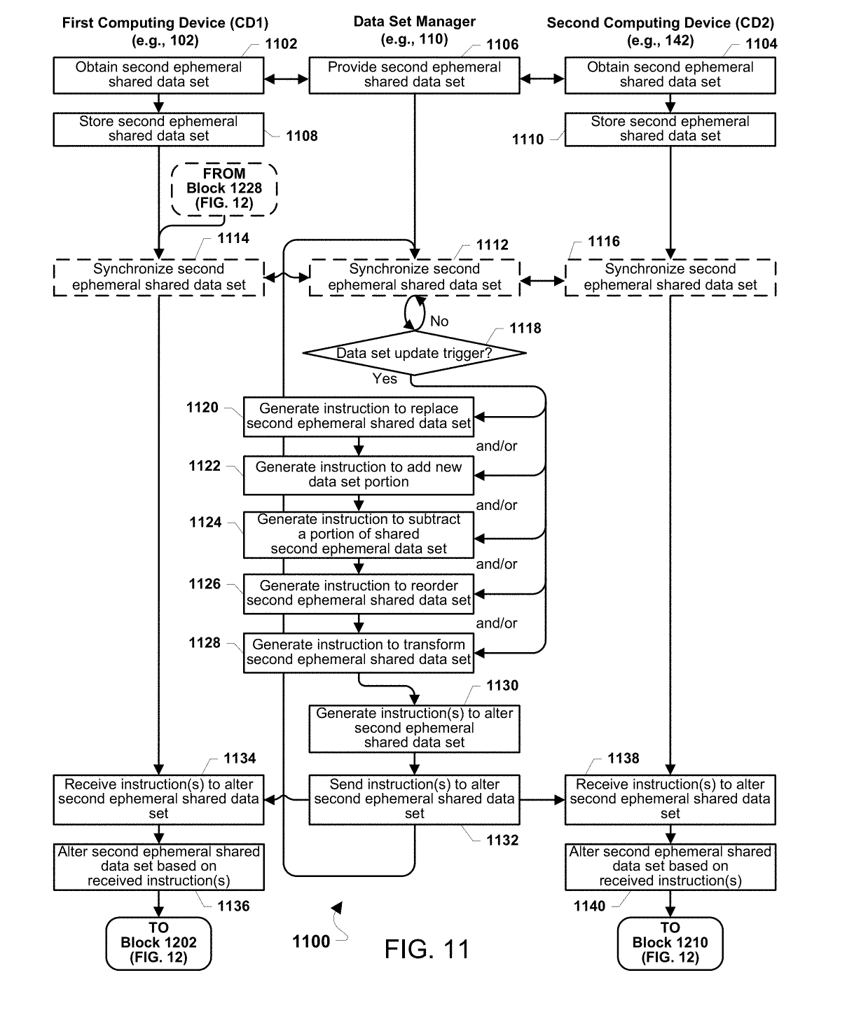

FIG. 11 illustrates a method 1100 of managing synchronization of an ephemeral shared data set of computing devices according to various embodiments. With reference to FIGS. 1A-11, the method 1100 may be implemented by a processor (e.g., the processor 202 and/or the like) of a computing device (e.g., the computing devices 102 and 142) and/or a data set manager (e.g., the network element 110).

In some embodiments, each computing device (e.g., 102, 142) may perform the operations of the methods 800, 900, and 1000 with a respective access point (e.g., 106, 146), and subsequently, the computing devices 102, 142 and the data set manager may perform the operations of the method 1100.

In block 1102, a processor of a first computing device (CD1) (e.g., the computing device 102, 106) may obtain a second ephemeral shared data set.

In block 1104, a processor of a second computing device (CD2) (e.g., the computing device 102, 106) may obtain the second ephemeral shared data set.

In block 1106, a processor of a data set manager (e.g., data set management device, for example, the network element 110) may provide the second ephemeral shared data set to CD1 and CD2. In some embodiments, the second ephemeral shared data set may include some or all of a data set stored at and managed by the data set manager (e.g., the data set 400, 500a, 500b, 50c, 500d, and 600).

In various embodiments, the second ephemeral shared data set may be the same as, or different from, the ephemeral shared data set described above with respect to the methods 700-1000.

In block 1108, the processor of CD1 may store the second ephemeral shared data set (e.g., in the storage 104). In block 1110, the processor of CD2 may store the second ephemeral shared data set (e.g., in the storage 108).

In optional block 1112, the processor of the data set manager may perform one or more operations to synchronize the second ephemeral shared data set. In optional block 1114, the processor of CD1 may perform one or more operations to synchronize the second ephemeral shared data set. In optional block 1116, the processor of CD2 may perform one or more operations to synchronize the second ephemeral shared data set. In various embodiments, the synchronization operations of blocks 1112, 1114, and 1116 may be initiated by the data set manager, CD1, or CD2. The synchronization operations of block 1112, 1114, and 1116 may include the transmission and/or exchange of one or more messages indicating the status and/or state of the second ephemeral shared data set stored at each of the data set manager, CD1, and CD2. The synchronization operations of block 1112, 1114, and 1116 may include performing by the processor of the data set manager, CD1, and CD2, one or more analyses of their respective stored second ephemeral shared data sets, such as a determining a checksum, performing a hash, and the like.

In determination block 1118, the processor of the data set manager may determine whether a data set update trigger has occurred. For example, the processor may determine whether a period of time has elapsed. As another example, the processor may determine whether a trigger event has occurred. The trigger event may include, for example, using a second ephemeral shared data set in an authentication process, such as extracting element(s) from second ephemeral shared data set, determining a value from the element(s), etc., as further described below. In some embodiments, the trigger event may include, for example, using a second ephemeral shared data set in an encryption process, as further described below. The trigger event may include, for example, a request from one or more computing devices to update the second ephemeral shared data set.

In response to determining that a data set update trigger has not occurred (i.e., determination block 1118=“No”), the processor of the data set manager may again perform operations to synchronize the second ephemeral shared data set in optional block 1112. The processors of CD1 and CD2 may also perform operations to synchronize the second ephemeral shared data set in optional block 1114 and 1116, respectively.

In response to determining that a data set update trigger has occurred (i.e., determination block 1118=“Yes”), the processor may perform one or more operations to dynamically alter the second ephemeral shared data set.

For example, the processor of the data set manager may generate an instruction to replace the second ephemeral shared data set in block 1120. In some embodiments, the processor of the data set manager may determine the replacement (new) data set. In some embodiments, the replacement data set may include one or more portions of the data set managed by the data set manager.

Additionally or alternatively, the processor of the data set manager may generate an instruction to add a new data set portion in block 1122. In some embodiments, the new data set portion may be based on received data inputs (e.g., the data inputs 130). In some embodiments, the processor of the data set manager may generate the new data set portion to be added. In some embodiments, the generated instructions may include instructions enabling the generation of the new data set portion (which may, e.g. be sent to CD1 and CD2, as described below).

Additionally or alternatively, the processor of the data set manager may generate an instruction to subtract a portion of the second ephemeral shared data set in block 1124.

Additionally or alternatively, the processor may generate an instruction to reorder the second ephemeral shared data set in block 1126. For example, reordering the second ephemeral shared data set may include placing one or more portions of the second ephemeral shared data set into a different time, location, position, or other difference relative to other portions of the second ephemeral shared data set.

Additionally or alternatively, the processor may generate an instruction to transform the second ephemeral shared data set in block 1128. For example, the processor may generate an instruction to transform one or more elements and/or one or more portions of the second ephemeral shared data set. In various embodiments, transforming a portion and/or an element of the second ephemeral shared data set portion may include performing one or more operations to alter one or more values of the element and/or portion. For example, transforming an element and/or a portion of an image or a video file may include rotating, flipping, inverting, shifting a position, shifting a color, applying a filter or preset transformation (e.g., as may be available in a photo or video editing software program), or another similar operation. As another example, transforming an element and/or a portion of a music or audio file may include raising or lowering pitches, reversing the content of the file, inverting the content of the audio file (i.e., transforming the content along a selected axis), adding an audio effect such as reverb, distortion, flanging, and the like, or another similar operation. As another example, transforming an element and/or a portion of the second ephemeral shared data set may include transcoding data elements (e.g., transforming audio data into visual data or text). As another example, transforming an element and/or a portion of the second ephemeral shared data set may include performing one or more mathematical functions to transform the element and/or portion.

In block 1130, the processor may generate one or more instructions to alter the second ephemeral shared data set. The one or more instructions may be based on the instruction to replace the second ephemeral shared data set, the instruction to add a new data set portion (and/or the generated new data set portion), the instruction to subtract a portion of the second ephemeral shared data set, the instruction to re-order the second ephemeral shared data set, and/or the instruction to transform the second ephemeral shared data set.

In block 1132, the processor of the second computing device may send the one or more instructions to alter the second ephemeral shared data set to CD1 and CD2.

In block 1134, the processor of CD1 may receive the one or more instructions to alter the second ephemeral shared data set.

In block 1136, the processor of CD1 may alter its stored copy of the second ephemeral shared data set based on the received one or more instructions.

In block 1138, the processor of CD2 may receive the one or more instructions to alter the second ephemeral shared data set.

In block 1140, the processor of CD2 may alter its stored copy of the second ephemeral shared data set based on the received one or more instructions.

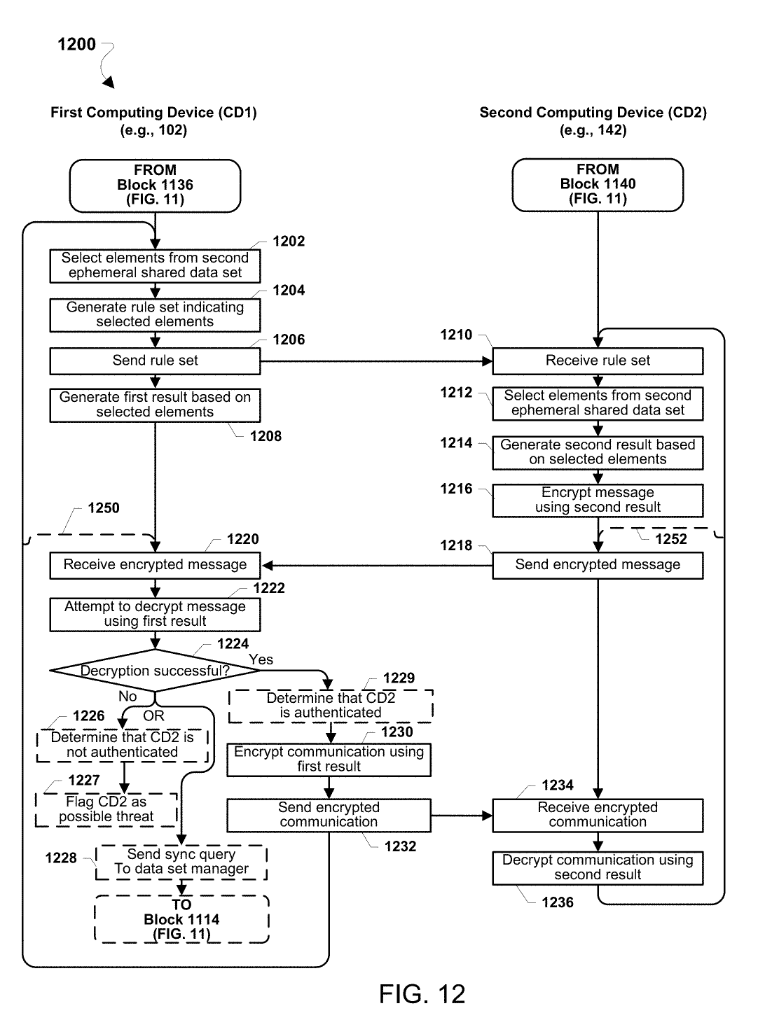

FIG. 12 illustrates a method 1200 for protecting a communication between computing devices according to various embodiments. With reference to FIGS. 1A-12, the method 1200 may be implemented may be implemented by a processor (e.g., the processor 202 and/or the like) of a computing device (e.g., the computing devices 102 and 142).

Various embodiments protect communications between computing devices by utilizing a dynamically changing encryption based on a dynamically changing shared information context. The information context may include, for example, a dynamically changing shared data set. The dynamically changing shared information context may be a unique data set shared only by the computing devices. In various embodiments, the operations of the method 1200 may be used in conjunction with the operations of the methods 700-1100. In some embodiments, the computing devices may communicate via an access point (e.g., the access points 106, 146). In some embodiments, the computing devices may each be connected to a respected access point (e.g., the computing device 102 may communicate via the access point 106, and the computing device 142 may communicate via the access point 146).

In block 1202, the processor of a first computing device (CD1) may select elements from the second ephemeral shared data set. For example, the processor of CD1 may select elements 420, 422, 424, and 428 from among the portions 402, 404, and 406 of the shared data set 400. As another example, the processor of CD1 may select elements from among the shared data sets 500a, 500b, 500c, 500d, and 600. In some embodiments, the processor of CD1 may select the elements randomly from the second ephemeral shared data set.

In block 1204, the processor of CD1 may generate a rule set indicating the selected elements. For example, the computing device processor may select one or more elements from one or more portions of the ephemeral shared data set, and may generate the rule set identifying the selected two or more elements. In some embodiments, the processor of CD1 may determine one or more relationships between the selected two or more elements, and may generate the rule set based on the determined one or more relationships between the selected two or more elements. In some embodiments, the relationship(s) may be based on one or more comparative or relational differences between or among the elements, such as those described above with respect to ephemeral shared data sets 400, 500a-500d, and 600. In some embodiments, the rule set may indicate a number system to be used in identifying and selecting elements from the shared data set, such as decimal, octal, hexadecimal, etc. In some embodiments, the rule set may indicate an encryption protocol to be used by the computing device and the access point. In various embodiments, the rule set may indicate two or more encryption protocols to be used, so that the encryption protocol employed by the computing device and the access point changes over time.

In block 1206, the processor of CD1 may send the rule set to the second computing device (CD2).

In block 1208, the processor of CD1 may generate a first result based on the selected elements.

In block 1210, the processor of CD2 may receive the rule set from the computing device.

In block 1212, the processor of CD2 may select elements from its stored version of the ephemeral shared data set using the rule set. For example, the processor of CD2 may use identifiers of each of the selected elements (e.g., one or more of the elements 420-428, or one or more of the elements of the ephemeral shared data sets 500a-500d or 600) to select the elements from the ephemeral shared data set stored at the access point. As another example, the processor of CD2 may use one or more identifiers of one of the elements and one or more relationships among the selected elements to select the elements from the ephemeral shared data set.

In block 1214, the processor of CD2 may generate a second result based on the selected elements. In some embodiments, the second result may include a string of data. In some embodiments, the second result may include a value based on the information in the selected elements of the shared data set. In some embodiments, the processor of CD2 may perform a transform of the information of the selected elements, such as generating a hash of values within the information. In some embodiments, the processor of CD2 may generate a data string based on the information of the selected elements and may perform a transform (e.g., generate a hash) of the information of the selected elements to generate the first result. In various embodiments, the processor of CD2 may use the same method of generating the second result that the computing device processor uses to generate the first result.

In block 1216, the processor of CD2 may encrypt a message using the second result. In some embodiments, the processor of CD2 may encrypt the message using the second result. In some embodiments, the processor of CD2 may use an encryption method such as MD5, SHA2, SHA256, BLAKE2, and the like, together with the second result to encrypt the message. In some embodiments, the message may serve as a test message to enable the processor of CD1 to determine whether the second result generated by the processor of CD2 matches the first result generated by the processor of CD1.

In block 1218, the processor of CD2 may send the encrypted message to the computing device.

In block 1220, the processor of CD1 may receive the encrypted message.

In block 1222, the processor of CD1 may attempt to decrypt the message using the first result. For example, the processor of CD1 may initiate a decryption process of the message. In some embodiments, the processor of CD1 may attempt to decrypt the message using the first result. In some embodiments, the processor of CD1 may use decryption format such as MD5, SHA2, SHA256, BLAKE2, and the like to attempt the decryption of the message, with or without using the first result.

In determination block 1224, the processor of CD1 may determine whether the decryption of the message from CD2 was successful. In some embodiments, a successful decryption of the encrypted message from the access point may indicate that the first result and the second result match. In some embodiments, the processor of CD1 may enable CD1 to communicate with CD2 in response to determining that the decryption of the message from CD2 was successful.

In response to determining that the decryption was not successful (i.e., determination block 1224=“No”), in some embodiments the processor of CD1 may determine that the access point is not authenticated in optional block 1226.

In optional block 1027, the processor of CD1 may flag CD2 as a possible threat. For example, the processor of CD1 may store an indication in memory that access point is a potential attacker or another threat to CD1, to an access point (e.g., the access points 106, 146), and/or to a network including the access point(s).

In response to determining that the decryption was not successful (i.e., determination block 1226=“No”), in some embodiments the processor of CD1 may send a synchronization query to the data set manager in optional block 1228. In some embodiments, after sending of the synchronization query, the processor of CD1 may attempt to synchronize its ephemeral shared data set. In some embodiments, following the sending of the synchronization query, the processors of the data set manager, CD1, and CD2 may perform operations to synchronize the shared data set, in optional block 1112, 1114, and 1116, respectively.

In some embodiments, in response to determining that the decryption was successful (i.e., determination block 1224=“Yes”), the processor of CD1 may determine that CD2 is authenticated in optional block 1229. In such embodiments, the processor of CD1 may encrypt a communication using the first result in block 1230.

In some embodiments, in response to determining that the decryption was successful (i.e., determination block 1224=“Yes”), the processor of CD1 may encrypt a communication using the first result in block 1230. For example, the processor of CD1 may encrypted a communication intended for the access point.

In block 1232, the processor of CD1 may send the encrypted communication to the access point.

In block 1234, the processor of CD2 may receive the encrypted communication from the computing device.

In block 1236, the processor of CD2 may decrypt the communication from the computing device using the second result. In some embodiments, the processor of CD2 may again receive a rule set from the computing device in block 1210.

In some embodiments, rather than returning to the operations of block 1202, the processor of CD1 may optionally perform (1250) the operations of block 1220 and receive an encrypted message from CD2. Similarly, in some embodiments, rather than return to the operations of block 1210, the processor of CD2 may optionally perform (1252) the operations of block 1218 and send an encrypted message from CD2. In such embodiments, the processor of CD1 may use the first result, and the processor of CD2 may use the second result, for multiple messages.

The method 1200 is not limited to the sending of a communication from the CD1 to CD2, and in various embodiments the processor of CD2 may perform the operations described above with respect to the processor of CD1, and vice versa. In some embodiments, the processors of CD1 and CD2 may perform their respective operations of the method 1200 so that CD1 may send an encrypted communication to CD2, and may subsequently switch roles, so that CD2 may send an encrypted communication to CD1.

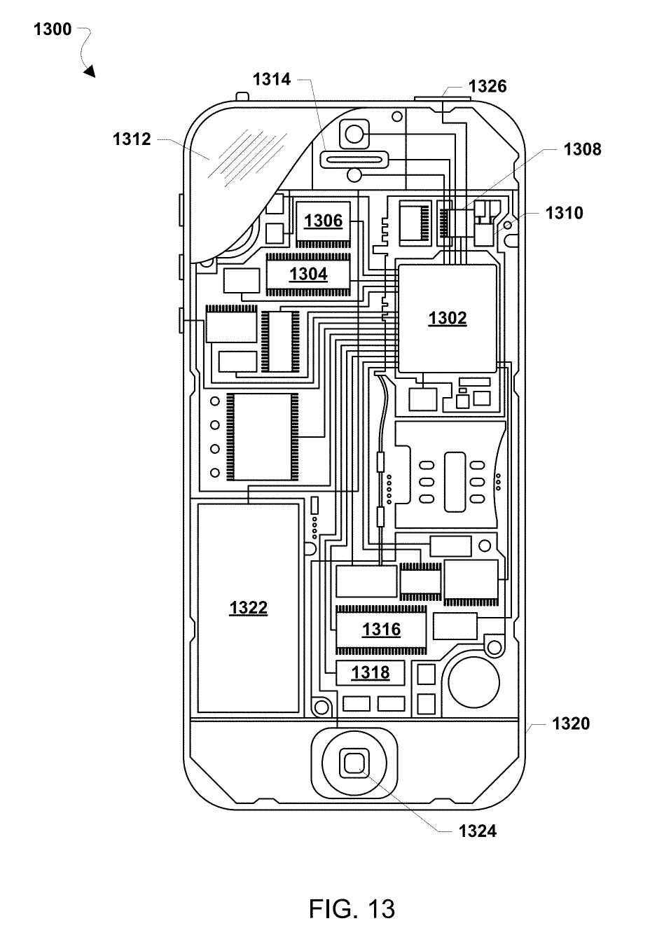

FIG. 13 is a component block diagram of a mobile wireless communication device 1300 suitable for implementing various embodiments. With reference to FIGS. 1A-13, the mobile wireless communication device 1300 may include a processor 1302 coupled to a touchscreen controller 1306 and an internal memory 1304. The processor 1302 may be one or more multi-core integrated circuits designated for general or specific processing tasks. The internal memory 1304 may be volatile or non-volatile memory, and may also be secure and/or encrypted memory, or unsecure and/or unencrypted memory, or any combination thereof. The touchscreen controller 1306 and the processor 1302 may also be coupled to a touchscreen panel 1312, such as a resistive-sensing touchscreen, capacitive-sensing touchscreen, infrared sensing touchscreen, etc. Additionally, the display of the mobile wireless communication device 1300 need not have touch screen capability.

The mobile wireless communication device 1300 may have two or more radio signal transceivers 1308 (e.g., Bluetooth, Zigbee, Wi-Fi, radio frequency (RF), etc.) and antennae 1310, for sending and receiving communications, coupled to each other and/or to the processor 1302. The transceivers 1308 and antennae 1310 may be used with the above-mentioned circuitry to implement the various wireless transmission protocol stacks and interfaces. The mobile wireless communication device 1300 may include one or more cellular network wireless modem chip(s) 1316 coupled to the processor and antennae 1310 that enables communication via two or more cellular networks via two or more radio access technologies.

The mobile wireless communication device 1300 may include a peripheral wireless device connection interface 1318 coupled to the processor 1302. The peripheral wireless device connection interface 1318 may be singularly configured to accept one type of connection, or may be configured to accept various types of physical and communication connections, common or proprietary, such as USB, FireWire, Thunderbolt, or PCIe. The peripheral wireless device connection interface 1318 may also be coupled to a similarly configured peripheral wireless device connection port (not shown).

The mobile wireless communication device 1300 may also include speakers 1314 for providing audio outputs. The mobile wireless communication device 1300 may also include a housing 1320, constructed of a plastic, metal, or a combination of materials, for containing all or some of the components discussed herein. The mobile wireless communication device 1300 may include a power source 1322 coupled to the processor 1302, such as a disposable or rechargeable battery. The rechargeable battery may also be coupled to the peripheral wireless device connection port to receive a charging current from a source external to the mobile wireless communication device 1300. The mobile wireless communication device 1300 may also include a physical button 1324 for receiving user inputs. The mobile wireless communication device 1300 may also include a power button 1326 for turning the mobile wireless communication device 1300 on and off.

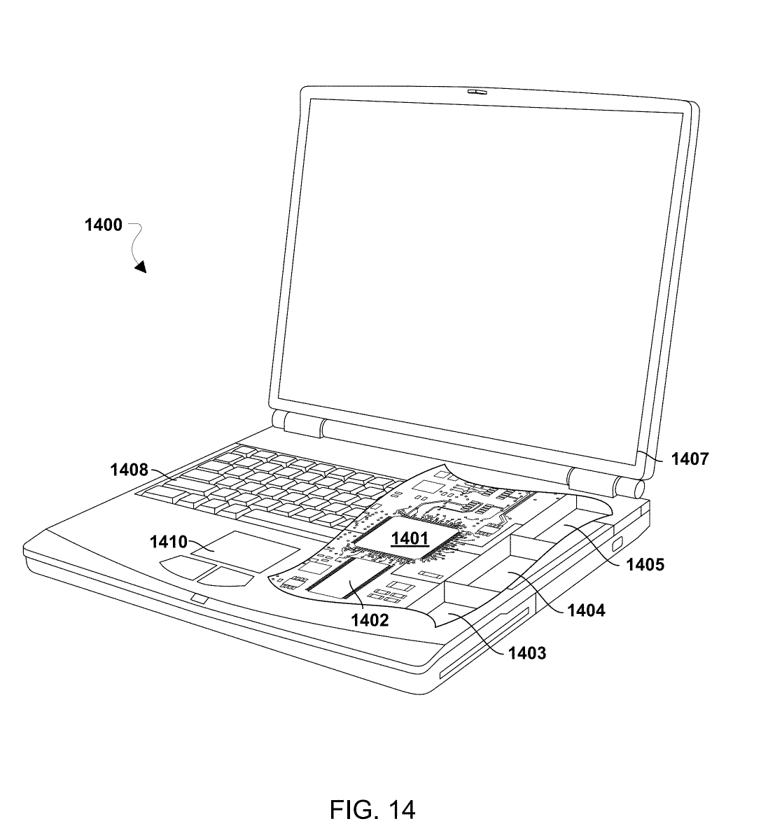

Other forms of computing devices may also benefit from the various embodiments. Such computing devices typically include the components illustrated in FIG. 14, which illustrates an example laptop computer 1400. With reference to FIGS. 1-14, the computer 1400 generally includes a processor 1401 coupled to volatile memory 1402 and a large capacity nonvolatile memory, such as a disk drive 1403. The computer 1400 may also include a compact disc (CD) and/or DVD drive 1404 coupled to the processor 1401. The computer 1400 may also include a number of connector ports coupled to the processor 1401 for establishing data connections or receiving external memory devices, such as a network connection circuit 1405 for coupling the processor 1401 to a network. The computer 1400 may also include a display 1407, a keyboard 1408, a pointing device such as a trackpad 1410, and other similar devices.

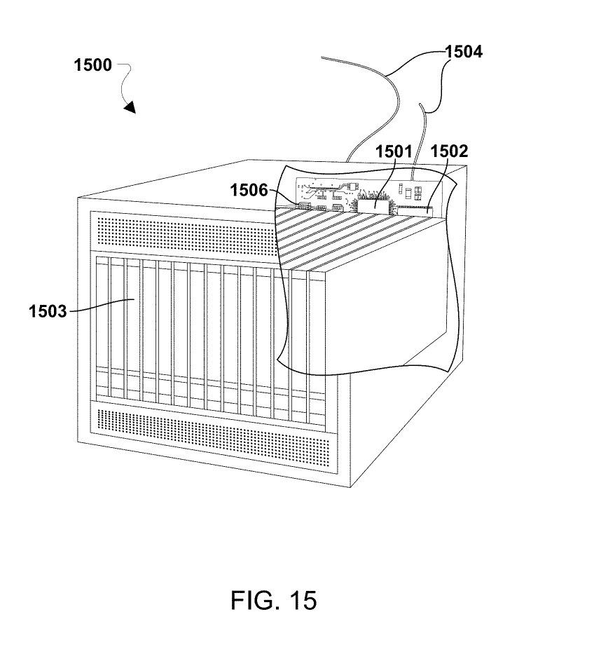

Various embodiments may employ a computing device as a network element of a communication network. Such network elements may typically include at least the components illustrated in FIG. 15, which illustrates an example network element, server device 1500. With reference to FIGS. 1-15, the server device 1500 may typically include a processor 1501 coupled to volatile memory 1502 and a large capacity nonvolatile memory, such as a disk drive 1503. The server device 1500 may also include a peripheral memory access device such as a floppy disc drive, compact disc (CD) or digital video disc (DVD) drive 1506 coupled to the processor 1501. The server device 1500 may also include network access ports 1504 (or interfaces) coupled to the processor 1501 for establishing data connections with a network, such as the Internet and/or a local area network coupled to other system computers and servers. Similarly, the server device 1500 may include additional access ports, such as USB, Firewire, Thunderbolt, and the like for coupling to peripherals, external memory, or other devices.

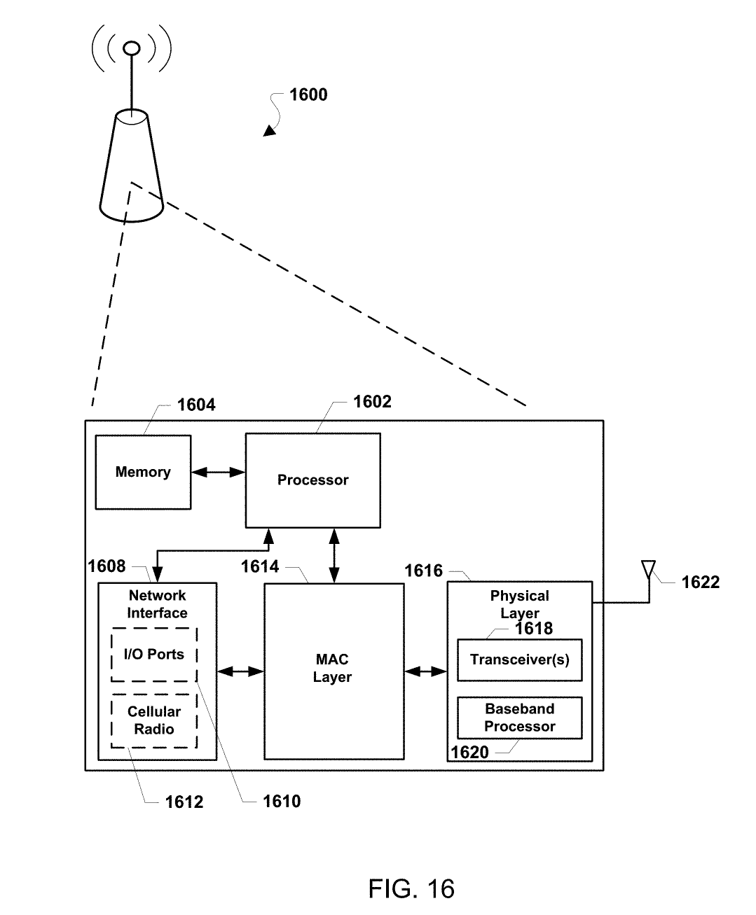

Other forms of computing devices may also benefit from the various embodiments. Such computing devices typically include the components illustrated in FIG. 16, which illustrates an example of an access point 1600 suitable for implementing various embodiments. With reference to FIGS. 1A-16, the access point 1600 may include at least one controller, such as a processor 1602. The processor 1602 may be a processor configurable with processor-executable instructions to execute operations of the various embodiments, a specialized processor, such as a modem processor, configurable with processor-executable instructions to execute operations of the various embodiments in addition to a primary function, a dedicated hardware (i.e., “firmware”) circuit configured to perform operations of the various embodiments, or a combination of dedicated hardware/firmware and a programmable processor.

The processor 1602 may be coupled to memory 1604, which may be a non-transitory computer-readable storage medium that stores processor-executable instructions. The memory 1604 may store an operating system, as well as user application software and executable instructions. The memory 1604 may also store application data, such as an array data structure. The memory 1604 may include one or more caches, read only memory (ROM), random access memory (RAM), electrically erasable programmable ROM (EEPROM), static RANI (SRAM), dynamic RAM (DRAM), or other types of memory. The processor 1602 may read and write information to and from the memory 1604. The memory 1604 may also store instructions associated with one or more protocol stacks. A protocol stack generally includes computer executable instructions to enable communication using a radio access protocol or communication protocol.

The processor 1602 may also be coupled to a network load monitor unit 206, and an association/dissociation monitor unit 228. In some embodiments, the network load monitor unit 206 may use information from the physical layer 216, a medium access control (MAC) layer 214, and/or the processor 202 to determine a network load of the access point caused by one or more associated client devices (e.g., the client devices 102, 104, 106). In some embodiments, the network load monitor unit 206 may receive information from the physical layer 216 and/or the MAC layer 214 and provide such information to the processor 202 for determination of the network load.

The access point 1600 may also include a network interface 1608 for connecting to a broadband network, such as the Internet. The access point 1600 may provide various computing devices with access to a communication network. The network interface 1608 may include one or more input/output (I/O) ports 210 through which a connection to a network may be provided. For example, the I/O ports 1610 may include an Ethernet connection, a fiber optic connection, a broadband cable connection, a telephone line connection, or other types of wired communication connections. Alternatively or in addition to the I/O ports 1610, the network interface 1608 may include a cellular radio unit 1612 that provides a connection to a mobile telephony system or cellular data network through which access to the Internet may be acquired.

The processor 1602 may be coupled to the MAC layer 1614. The MAC layer 1614 may provide addressing and channel access control mechanisms between the network interface 1608 and one or more devices associated with the access point 1600, such as wireless client devices and/or range extenders. The MAC layer 1614 may be connected to a physical layer 1616, which may perform various encoding, signaling, and data transmission and reception functions. The physical layer 1616 may include one or more transceivers 1618 and a baseband processor 1620 for carrying out the various functions of the physical layer 1616. The physical layer 1616 may be coupled to one or more wireless antennas (e.g., wireless antenna 1622) to support wireless communications with devices associated with the access point 1600, such as wireless client devices and/or range extenders. The transceivers 1618 may be configured to provide communications using one or more frequency bands. Such frequency bands may include, for example, 2.4 GHz, lower band 5 GHz, and higher band 5 GHz. Additional examples include 900 MHz (e.g., as may be described with reference to IEEE 802.11ah), 60 GHz (e.g., as may be described with reference to IEEE 802.11ad), and “TV whitespace” frequency bands between 54 and 790 MHz (e.g., so-called “White-Fi” or “Super Wi-Fi” bands, as may be described with reference to IEEE 802.11af).

The access point 1600 may also include a bus for connecting the various components of the access point 1600 together, as well as hardware and/or software interfaces to enable communication among the various components. The access point 1600 may also include various other components not illustrated in FIG. 16. For example, the access point 1600 may include a number of input, output, and processing components such as buttons, lights, switches, antennas, display screen or touchscreen, various connection ports, additional processors or integrated circuits, and many other components.

The processors 1302, 1401, 1501, 1602 may be any programmable microprocessor, microcomputer or multiple processor chip or chips that can be configured by software instructions (applications) to perform a variety of functions, including the functions of the various embodiments described herein. In some mobile devices, multiple processors 1302 may be provided, such as one processor dedicated to wireless communication functions and one processor dedicated to running other applications. Typically, software applications may be stored in the internal memory 1304, 1402, 1502, 1604 before they are accessed and loaded into the processor 1302, 1401, 1501, 1602. The processor 1302, 1401, 1501, 1602 may include internal memory sufficient to store the application software instructions.

Various embodiments enhance and improve the security function of any communication network or any electronic communication system by improving the security of communications by utilizing a dynamically changing shared information context. Various embodiments also enhance and improve the security of communications on a communication network by utilizing a dynamically generated result based on the dynamically changing shared information context. The information context may include, for example, a dynamically changing shared data set. Various embodiments also improve the security function of any communication network by using a dynamic shared data set and a dynamically generated value based on the dynamic shared data set, without relying on easily compromised static identification information (such as a shared secret) that may be vulnerable to unauthorized access and copying. Various embodiments employ the dynamically-changing shared data and the dynamically generated value to protect communications in a manner that does not rely on the paradigm of shared secrets and static information.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 300, 700, 800, 900, 1000, 1100, and 1200, may be substituted for or combined with one or more operations of the methods 300, 700, 800, 900, 1000, 1100, and 1200.

Various embodiments may be implemented in any number of single or multi-processor systems. Generally, processes are executed on a processor in short time slices so that it appears that multiple processes are running simultaneously on a single processor. When a process is removed from a processor at the end of a time slice, information pertaining to the current operating state of the process is stored in memory so the process may seamlessly resume its operations when it returns to execution on the processor. This operational state data may include the process's address space, stack space, virtual address space, register set image (e.g., program counter, stack pointer, instruction register, program status word, etc.), accounting information, permissions, access restrictions, and state information.

A process may spawn other processes, and the spawned process (i.e., a child process) may inherit some of the permissions and access restrictions (i.e., context) of the spawning process (i.e., the parent process). A process may be a heavy-weight process that includes multiple lightweight processes or threads, which are processes that share all or portions of their context (e.g., address space, stack, permissions and/or access restrictions, etc.) with other processes/threads. Thus, a single process may include multiple lightweight processes or threads that share, have access to, and/or operate within a single context (i.e., the processor's context).

The foregoing method descriptions and the process flow diagrams are provided merely as illustrative examples and are not intended to require or imply that the blocks of various embodiments must be performed in the order presented. As will be appreciated by one of skill in the art, the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of communication devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A computing device, comprising:
a memory; and
a processor coupled to the memory and configured with processor-executable instructions to perform operations comprising:
selecting elements from an ephemeral shared data set stored in the computing device and in an access point;
generating a rule set indicating the selected elements;
generating a first dynamic session key based on the selected elements;
sending the generated rule set to the access point;
receiving a second dynamic session key from the access point;
determining whether the first dynamic session key matches the second dynamic session key; and
determining that the access point is authenticated in response to determining that the first dynamic session key matches the second dynamic session key.

2. The computing device of claim 1, wherein the processor is configured with processor-executable instructions to perform operations such that selecting elements from an ephemeral shared data set stored in the computing device and in the access point is performed in response to one of sending a handshake request to the access point and receiving a handshake request from the access point.

3. The computing device of claim 1, wherein the processor is configured with processor-executable instructions to perform operations further comprising:
enabling communication with the access point in response to determining that the access point is authenticated.

4. The computing device of claim 1, wherein the processor is configured with processor-executable instructions to perform operations further comprising:
determining that the access point is not authenticated in response to determining that the first dynamic session key does not match the second dynamic session key.

5. The computing device of claim 4, wherein the processor is configured with processor-executable instructions to perform operations further comprising:
preventing communication with the access point in response to determining that the access point is not authenticated.

6. The computing device of claim 1, wherein the processor is configured with processor-executable instructions to perform operations further comprising:
selecting second elements from a second ephemeral shared data set stored in the computing device and a second computing device;
generating a second rule set indicating the selected second elements;
generating a first result the selected second elements;
sending the second rule set to the second computing device via the access point;
receiving an encrypted message from the second computing device via the access point;
attempting to decrypt the encrypted message using the first result; and
determining whether the attempted decryption was successful.

7. The computing device of claim 6, wherein the processor is configured with processor-executable instructions to perform operations further comprising:
determining that the second computing device is authenticated in response to determining that the attempted decryption was successful.

8. The computing device of claim 6, wherein the processor is configured with processor-executable instructions to perform operations further comprising:
encrypting a communication using the first result in response to determining that the attempted decryption was successful; and
sending the encrypted communication to the second computing device via the access point.

9. A method of protecting device communication, comprising:
selecting elements from an ephemeral shared data set stored in a computing device and in an access point;
generating a rule set indicating the selected elements;
generating a first dynamic session key based on the selected elements;
sending the generated rule set to the access point;
receiving a second dynamic session key from the access point;
determining whether the first dynamic session key matches the second dynamic session key; and
determining that the access point is authenticated in response to determining that the first dynamic session key matches the second dynamic session key.

10. The method of claim 9, wherein selecting elements from an ephemeral shared data set stored in the computing device and in the access point is performed in response to one of sending by the computing device a handshake request to the access point and receiving by the computing device a handshake request from the access point.

11. The method of claim 9, further comprising:
enabling communication with the access point in response to determining that the access point is authenticated.

12. The method of claim 9, further comprising:
determining that the access point is not authenticated in response to determining that the first dynamic session key does not match the second dynamic session key.

13. The method of claim 12, further comprising:
preventing communication with the access point in response to determining that the access point is not authenticated.

14. The method of claim 9, further comprising:
selecting second elements from a second ephemeral shared data set stored in the computing device and a second computing device;
generating a second rule set indicating the selected second elements;
generating a first result the selected second elements;
sending the second rule set to the second computing device via the access point;
receiving an encrypted message from the second computing device via the access point;
attempting to decrypt the encrypted message using the first result; and
determining whether the attempted decryption was successful.

15. The method of claim 14, further comprising:
determining that the second computing device is authenticated in response to determining that the attempted decryption was successful.

16. The method of claim 14, further comprising:
encrypting a communication using the first result in response to determining that the attempted decryption was successful; and
sending the encrypted communication to the second computing device via the access point.

17. A computing device, comprising:
means for selecting elements from an ephemeral shared data set stored in the computing device and in an access point;
means for generating a rule set indicating the selected elements;
means for generating a first dynamic session key based on the selected elements;
means for sending the generated rule set to the access point;
means for receiving a second dynamic session key from the access point;
means for determining whether the first dynamic session key matches the second dynamic session key; and
means for determining that the access point is authenticated in response to determining that the first dynamic session key matches the second dynamic session key.

18. The computing device of claim 17, further comprising:
means for communicating a handshake request with the access point.

19. The computing device of claim 17, further comprising:
means for enabling communication with the access point in response to determining that the access point is authenticated.

20. The computing device of claim 17, further comprising:
means for determining that the access point is not authenticated in response to determining that the first dynamic session key does not match the second dynamic session key.

21. The computing device of claim 20, further comprising:
means for preventing communication with the access point in response to determining that the access point is not authenticated.

22. The computing device of claim 17, further comprising:
means for selecting second elements from a second ephemeral shared data set stored in the computing device and a second computing device;
means for generating a second rule set indicating the selected second elements;
means for generating a first result the selected second elements;
means for sending the second rule set to the second computing device via the access point;
means for receiving an encrypted message from the second computing device via the access point;
means for attempting to decrypt the encrypted message using the first result; and
means for determining whether the attempted decryption was successful.

23. The computing device of claim 22, further comprising:
means for determining that the second computing device is authenticated in response to determining that the attempted decryption was successful.

24. The computing device of claim 22, further comprising:
means for encrypting a communication using the first result in response to determining that the attempted decryption was successful; and
means for sending the encrypted communication to the second computing device via the access point.

25. A non-transitory processor-readable storage medium having stored thereon processor-executable instructions configured to cause a processor of a computing device to perform operations comprising:
selecting elements from an ephemeral shared data set stored in the computing device and in an access point;
generating a rule set indicating the selected elements;
generating a first dynamic session key based on the selected elements;
sending the generated rule set to the access point;
receiving a second dynamic session key from the access point;
determining whether the first dynamic session key matches the second dynamic session key; and
determining that the access point is authenticated in response to determining that the first dynamic session key matches the second dynamic session key.

26. The non-transitory processor-readable storage medium of claim 25, wherein the stored processor-executable instructions are configured to cause the processor of the computing device to perform operations such that selecting elements from an ephemeral shared data set stored in the computing device and in the access point is performed in response to one of sending by the computing device a handshake request to the access point and receiving by the computing device a handshake request from the access point.

27. The non-transitory processor-readable storage medium of claim 25, wherein the stored processor-executable instructions are configured to cause the processor of the computing device to perform operations further comprising:
enabling communication with the access point in response to determining that the access point is authenticated.

28. The non-transitory processor-readable storage medium of claim 25, wherein the stored processor-executable instructions are configured to cause the processor of the computing device to perform operations further comprising:
determining that the access point is not authenticated in response to determining that the first dynamic session key does not match the second dynamic session key.

29. The non-transitory processor-readable storage medium of claim 28, wherein the stored processor-executable instructions are configured to cause the processor of the computing device to perform operations further comprising:
preventing communication with the access point in response to determining that the access point is not authenticated.

30. The non-transitory processor-readable storage medium of claim 25, wherein the stored processor-executable instructions are configured to cause the processor of the computing device to perform operations further comprising:
selecting second elements from a second ephemeral shared data set stored in the computing device and a second computing device;
generating a second rule set indicating the selected second elements;
generating a first result the selected second elements;
sending the second rule set to the second computing device via the access point;
receiving an encrypted message from the second computing device via the access point;
attempting to decrypt the encrypted message using the first result; and
determining whether the attempted decryption was successful.

31. The non-transitory processor-readable storage medium of claim 30, wherein the stored processor-executable instructions are configured to cause the processor of the computing device to perform operations further comprising:
determining that the second computing device is authenticated in response to determining that the attempted decryption was successful.

32. The non-transitory processor-readable storage medium of claim 30, wherein the stored processor-executable instructions are configured to cause the processor of the computing device to perform operations further comprising:
encrypting a communication using the first result in response to determining that the attempted decryption was successful; and
sending the encrypted communication to the second computing device via the access point.
